(19) United States
(12) Patent Application Publication
(10) Pub. No.: US 2024/0158557 A1
(43) Pub. Date: May 16, 2024

(54) MANUFACTURED POLYMERS HAVING ALTERED OLIGOSACCHARIDE OR POLYSACCHARIDE FUNCTIONALITY OR NARROWED OLIGOSACCHARIDE DISTRIBUTION, PROCESSES FOR PREPARING THEM, COMPOSITIONS CONTAINING THEM, AND METHODS OF USING THEM

(71) Applicant: NOURYON CHEMICALS INTERNATIONAL B.V., Amsterdam (NL)

(72) Inventors: Klin Aloysius RODRIGUES, Signal Mountain, TN (US); Matthew Michael VANDERHOOF, Chattanooga, TN (US); Sajal PANTHA, Ooltewah, TN (US)

(73) Assignee: NOURYON CHEMICALS INTERNATIONAL B.V., Amsterdam (NL)

(21) Appl. No.: 18/561,919

(22) PCT Filed: May 20, 2022
(86) PCT No.: PCT/EP2022/063771

§ 371 Date: Nov. 17, 2023

Related U.S. Application Data
(60) Provisional application No. 63/191,185, filed on May 20, 2021.

(30) Foreign Application Priority Data
Sep. 6, 2021 (EP) 21195067.0

(51) Int. Cl. C08F 251/02

(52) U.S. Cl. CPC C08F 251/02; C08F 2400/02

(57) ABSTRACT

A manufactured polymer comprises (A) a synthetic component covalently bonded to (B) a natural component, wherein the natural component comprises oligosaccharide or polysaccharide, and wherein an end group of said oligosaccharide or polysaccharide is when in an open-chain form substantially devoid of aldehyde functionality.

### CROSS-REFERENCE TO RELATED APPLICATIONS

This application is a U.S. National-Stage entry under 35 U.S.C. § 371 based on International Application No. PCT/EP2022/063771, filed May 20, 2022, which was published under PCT Article 21(2) and which claims priority of U.S. Provisional Application Ser. No. 63/191,185, filed May 20, 2021, and European Patent Application No. EP 21195067.0, filed Sep. 6, 2021, the entire contents of which patent applications are hereby incorporated herein by reference.

### FIELD OF THE DISCLOSURE

The present disclosure relates to manufactured polymers built from synthetic and natural components, wherein the natural components comprise in one embodiment oligosaccharide or polysaccharide that has been purposefully modified on an end group thereof to substantially eliminate aldehyde functionality when the end group is in an open-chain form; and in another embodiment a narrowed oligosaccharide distribution prepared by enzyme degradation of polysaccharide. The manufactured polymers have improved properties compared to their known counterparts.

### BACKGROUND OF THE DISCLOSURE

Various manufactured polymers are known in the prior art built from a combination of synthetic and naturally-derived materials, wherein the naturally-derived materials are utilized as chain transfer agents. See, for example, U.S. Pat. Nos. 7,666,963; 8,674,021; 8,227,381; 7,666,963; 8,058,374; 9,109,068; 9,321,873; 9,988,526; and 9,051,406, and published PCT applications WO 2015/124384; WO 2018/206811; and WO 2018/206812, the entire contents of which patents and patent applications are incorporated herein by reference. These manufactured polymers are advantageous over the synthetic polymers that had been utilized prior to their development because the manufactured polymers are at least partially derived from renewable natural sources and, therefore, have an improved renewability and biodegradability profile compared to their wholly synthetic counterparts.

U.S. Pat. No. 8,058,374, for example, describes such manufactured polymers that comprise long chains of synthetic monomers that incorporate at the end of the chain a moiety derived from natural material as a so-called “chain transfer agent.” In one embodiment, the chain transfer agent is a hydroxyl-containing naturally-derived material, for example, a monosaccharide, oligosaccharide, or polysaccharide, such as a sugar, corn syrup, maltodextrin, or starch.

Although the known manufactured polymers have found widespread use in various industries, they have been found to discolor under conditions of elevated pH and elevated temperatures during processing, storage, and end use. Such discoloration is undesirable because end use producers and their consumers have strong and specific expectations when it comes to the color of their products. Accordingly, the discoloration problem puts these manufactured polymers at increasing commercial disadvantage by reducing the chances producers will select these manufactured polymers for use in their products or that consumers will choose to purchase such products.

EP 0 087 995 B1 describes a copolymer of acrylamide and polysaccharide resin as electrophoretic gel medium. According to the teaching, when agar and agarose are reacted in solution with acyl and alkylating agents, such as alkenyl halides, allylglycidyl ether, acrylol chloride, crotonyl chloride, methacryloyl chloride, crotonyl chloride, methacrylol chloride, and 3-butenoyl, under alkaline conditions to form a derivatized polyol precursor that is in a subsequent step reacted with polyacrylamide to form the copolymer, some discoloration of the solution may occur that may be avoided by blocking the aldehyde end group of the agarose.

U.S. Pat. No. 5,578,678 describes graft polymers of mono-, oligo- and polysaccharides obtained by free radical polymerization of open-chain N-vinyl-carboxamides for use as dry and wet strength agents for paper, board and cardboard. There is a teaching that a first step in the preparation of such graft polymers involves degrading polysaccharide with enzyme. There is a further teaching that the N-vinyl-carboxamide is preferably a N-vinyl-formamide, and the polymer is subjected to hydrolysis to eliminate from 2 to 100% of the formyl groups. The patent also teaches color stability in storage can be improved by adding reducing agents or aldehyde acceptors either during or after the hydrolysis.

EP 0 725 131 A1 describes the preparation of graft polymers of mono-, oligo- and polysaccharides obtained by radical initiated polymerization of a monomer mixture containing 40 to 100% by weight of monoethylenically unsaturated C₃ to C₁₀ monocarboxylic acids and/or monoethylenically unsaturated C₄ to C₈ dicarboxylic acids, their anhydrides, alkali metal salts and/or ammonium salts for use as an additive for certain dishwashing detergents containing at least 5% by weight of at least one ammonium or alkali metal carbonate or an ammonium or alkali metal sulfate and at least 2% by weight of sodium silicate. According to the teaching, phosphate-free, low-foaming dishwashing detergents were known, but the cleaning resulting from the use of such detergents was not always satisfactory. The stated object was to provide dishwashing detergents that contained sodium silicate which, when used, left virtually no silicate deposits on machine dishwashing on crockery, cutlery, and glassware and whose polymeric components were produced with partial use of renewal raw materials and, therefore, had a significantly improved biodegradability. There is the further teaching that in order to prepare colorless or only slightly colored graft polymers it is necessary to carry out the polymerization in the presence of water-soluble phosphorus compounds, preferably phosphorous acid. In fact, all of the polymer preparation examples in this document include the addition of quantities of phosphorus acid. However, this is disadvantageous as the phosphorus is incorporated into the resulting polymer and is, therefore, present when the cleaning formulation is used. This phosphorus is then released to the environment with the spent dishwater, causing eutrophication of water bodies such as lakes, rivers, and oceans.

It is an object of the present disclosure to produce manufactured polymers substantially free of added phosphorus that do not discolor even under extreme conditions of pH and/or temperature, either during processing, or while being stored, or even when used by consumers. In addition, other objects, desirable features and characteristics will become apparent from the subsequent summary and detailed description, and the appended claims, taken in conjunction with the accompanying drawings and this background.

### BRIEF SUMMARY

This disclosure provides a manufactured polymer comprising (A) a synthetic component covalently bonded to (B) a natural component, wherein the natural component comprises an oligosaccharide or a polysaccharide, and wherein an end group of said oligosaccharide or said polysaccharide is substantially devoid of aldehyde functionality when in an open-chain form.

### BRIEF DESCRIPTION OF THE DRAWINGS

The present disclosure will hereinafter be described in conjunction with the following drawing figures, wherein:

FIG. 1 is a drawing depicting maltodextrin end group functionality in “closed-chain” and “open-chain” forms.

### DETAILED DESCRIPTION

The following detailed description is merely exemplary in nature and is not intended to limit the present disclosure or the application and uses of the present disclosure. Furthermore, there is no intention to be bound by any theory presented in the preceding background of the present disclosure or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

### Definitions

As used herein, the term “synthetic” means not occurring naturally.

As used herein, the term “natural” means occurring naturally.

As used herein, the term “manufactured polymer” means a polymer not occurring in nature, but rather prepared by synthetic techniques. The term embraces both “hybrid polymer” and “graft polymer” as defined herein below.

As used herein, the term “hybrid polymer” means a polymer containing a backbone chain containing both synthetic and natural monomer residues.

As used herein, the term “graft polymer” means a polymer containing a backbone chain, which may itself be a synthetic homopolymer, a natural homopolymer, or a synthetic/natural copolymer, to which backbone synthetic and/or natural monomer chains are attached.

As used herein, the term “saccharide” means a unit structure of a carbohydrate. Saccharides typically exist as a ring (“closed-chain form”) or in a short chain conformation (“open-chain form”), and typically contain 4-6 carbon atoms.

As used herein, the term “oligosaccharide” means a chain of saccharide units from 1 to 20 saccharide units in length.

As used herein, the term “polysaccharide” means a chain of saccharide units more than 21 saccharide units in length.

As used herein, the term “substantially free,” particularly as it relates to the phosphorus content, means less than 0.1 weight percent of phosphorus in the polymer, preferably less than 0.05 weight percent of phosphorus in the polymer, most preferably less than 0.01 weight percent of phosphorus in the polymer.

As used herein, the term “substantially free of added phosphorus” means that phosphorus beyond that naturally contained in the natural component, for example, a potato starch, is not introduced in quantities of more than 0.1 weight percent of phosphorus in the polymer, preferably no more than 0.05 weight percent of phosphorus in the polymer, most preferably no more than 0.01 weight percent of phosphorus in the polymer, for example, through the use of additives, such as water-soluble phosphorus compounds, for instance, phosphorous acid or its salts, during the preparation of the polymer and/or during pre-end use processing, transportation, and/or storage.

As used herein, the term “substantially eliminated” means with increasing preference, compared to a starting quantity, less than 10% remaining, or less than 5% remaining, or less than 2% remaining, or less than 1% remaining, or completely free of what was eliminated.

As used herein, the term “substantially devoid” means, compared to a precursor, containing less than 10% remaining, or less than 5% remaining, or less than 2% remaining, or less than 1% remaining, or completely free of what was contained in the precursor that has been eliminated.

As used herein, the term “known polymer precursor” refers to a known polymer that comprises end groups having the ability to exist in an open-chain form comprising aldehyde functionality. Such known polymer precursor can be modified by the techniques described herein to substantially eliminate the aldehyde functionality thereby stabilizing the resulting manufactured polymer against discoloration.

The present disclosure relates in one embodiment to a manufactured polymer comprising (A) a synthetic component covalently bonded to (B) a natural component, wherein the natural component comprises oligosaccharide or polysaccharide, and wherein an end group of said oligosaccharide or polysaccharide is when in an open-chain form substantially devoid of aldehyde functionality.

The present disclosure relates in another embodiment to a manufactured polymer comprising (A) a synthetic component covalently bonded to (B) natural a component, wherein the natural component comprises a mixture comprising monosaccharide having an oligomeric degree of polymerization DP1, a disaccharide having an oligomeric degree of polymerization DP2, a tetrasaccharide having an oligomeric degree of polymerization DP4, a pentasaccharide having an oligomeric degree of polymerization DP5, and a hexasaccharide having an oligomeric degree of polymerization DP6, wherein a sum of DP1+DP2 is less than 30 weight percent and a sum of DP4+DP5+DP6 is greater than 15 weight percent, based in each case on a total weight of the polymer.

The present disclosure relates in another embodiment to a process of preparing a manufactured polymer as described herein, said process comprising the following steps: (A) providing a polymer precursor mixture comprising (i) one or more monomer precursors of the synthetic component and (ii) oligosaccharide or polysaccharide comprising an end group having the ability to exist in an open-chain form comprising aldehyde functionality; and (B) polymerizing the polymer precursor mixture to form a manufactured polymer, wherein either before or after step (B), the aldehyde functionality is eliminated in whole or substantial part.

The present disclosure relates in another embodiment to a composition useful to prepare a manufactured polymer as described herein, said composition comprising (A) one or more monomer precursors of the synthetic component and (B) oligosaccharide or polysaccharide comprising an end group that when in an open-chain form is substantially devoid of aldehyde functionality.

The present disclosure relates in another embodiment to a process of preparing a manufactured polymer as described herein, said process comprising the following steps: (A) enzyme degrading polysaccharide to form the oligosaccharide; (B) providing a polymer precursor mixture comprising (i) one or more monomer precursors of the synthetic component and (ii) the oligosaccharide prepared in (A); and (C) polymerizing the polymer precursor mixture to form a manufactured polymer.

The present disclosure relates in another embodiment to a composition useful to prepare a manufactured polymer as described herein, said composition comprising (A) one or more monomer precursors of the synthetic component and (B) a mixture comprising monosaccharide having an oligomeric degree of polymerization DP1, a disaccharide having an oligomeric degree of polymerization DP2, a tetrasaccharide having an oligomeric degree of polymerization DP4, a pentasaccharide having an oligomeric degree of polymerization DP5, and a hexasaccharide having an oligomeric degree of polymerization DP6, wherein a sum of DP1+DP2 is less than 30 weight percent and a sum of DP4+DP5+DP6 is greater than 15 weight percent, based in each case on a total weight of the composition.

The present disclosure relates in another embodiment to a manufactured polymer prepared according to the processes described above.

The present disclosure relates in another embodiment to a formulation comprising a manufactured polymer as described herein and at least one additional ingredient.

The present disclosure relates in another embodiment to a method of preparing a formulation as described above comprising adding the manufactured polymer to the at least one additional ingredient.

The present disclosure relates in another embodiment to a method of cleaning a surface comprising contacting the surface with an effective amount of the formulation described above.

The present disclosure relates in another embodiment to a method for controlling scale in an aqueous system comprising introducing into the aqueous system an effective amount of a manufactured polymer as described herein.

The present disclosure relates in another embodiment to a method for dispersing particulates in an aqueous system comprising adding to the aqueous system an effective amount of a manufactured polymer as described herein.

The present disclosure relates in another embodiment to a method of caring for skin or hair comprising applying an effective amount of a manufactured polymer as described herein.

The present disclosure relates in another embodiment to a method of modifying the rheology properties of a formulation comprising incorporating into such formulation an effective amount of a manufactured polymer as described herein.

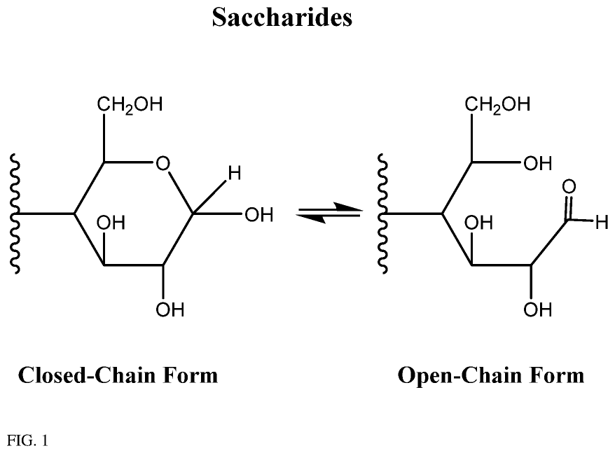

As shown in FIG. 1, at any given point in time, a very small portion of the saccharide end groups can exist in an “open-chain form” having aldehyde functionality. Without wishing to be bound by theory, we believe that in conditions of elevated temperature (e.g., 20-40° C. and above) and alkaline pH (above pH 7;), the aldehyde functionality reacts with residual proteins/amino acids and perhaps other moieties present from the polysaccharide source in a process called the Maillard reaction. This starts a complex series of reactions that ultimately discolor the manufactured polymer.

Excessively low or high pH (e.g., less than pH 3 or higher than pH 8) can also cause depolymerization of polysaccharide chains especially during the polymerization process. Depolymerization of the polysaccharide chains, in turn, increases the number of aldehyde-containing end groups.

The discoloration that we have observed, and which the present disclosure resolves, includes not only discoloration of a clear product to yellow or even brown, but also discoloration of a colored product, for example, one purposely dyed red or some other color, to a different shade of the same color or a different color altogether. What is desired is color stability over the life of the product, whether during the initial polymerization, in transport, throughout storage, and in use.

Indeed, without some sort of preventative treatment, manufactured polymers will generally turn very dark in the reactor during polymerization at standard reaction temperatures (80-95° C.) and across a broad range of pH values. Likewise, without some sort of preventative treatment, manufactured polymers may depolymerize and discolor during transport and storage, or during formulation. This is true of both manufactured polymers in the liquid or solid form. The solid form of these polymers are used in powder laundry detergents and unit dose tablets. Polymers

The scope of manufactured polymers that can benefit from the present disclosure are generally all known polymers with end group aldehyde functionality that may be susceptible to Maillard reaction in the manner herein described. Such known polymers can be modified in accordance with the teachings herein to yield manufactured polymers modified to substantially eliminate the aldehyde functionality, which manufactured polymers are therefore stable against discoloration.

In one embodiment, the manufactured polymer is a hybrid copolymer. Known polymer precursors of this type are described, for example, in U.S. Pat. No. 7,666,963, the entire contents of which are hereby incorporated herein by reference. The present disclosure extends to any of the polymers described therein modified by the techniques described herein to substantially eliminate aldehyde functionality in an end group saccharide moiety.

In one embodiment, the manufactured polymer is a sulfonated graft copolymer. Known polymer precursors of this type are described, for example, in U.S. Pat. No. 8,674,021, the entire contents of which are hereby incorporated herein by reference. The present disclosure extends to any of the polymers described therein modified by the techniques described herein to substantially eliminate aldehyde functionality in an end group saccharide moiety.

In one embodiment, the manufactured polymer is a low molecular weight graft copolymer. Known polymer precursors of this type are described, for example, in U.S. Pat. No. 8,227,381, the entire contents of which are hereby incorporated herein by reference. Such polymers have a number average molecular weight of about 100,000 Dalton or less, preferably about 25,000 Dalton or less, more preferably about 10, 000 Dalton or less. Methods for determining the number average molecular weight of graft copolymer and the polysaccharide used to make the graft polymer as set forth in column 24 of the '381 patent and incorporated herein by reference. The present disclosure extends to any of the polymers described therein modified by the techniques described herein to substantially eliminate aldehyde functionality in an end group saccharide moiety.

Molecular weights of the manufactured polymers described herein can be determined by aqueous Gel Permeation Chromatography (“GPC”) using a series of polymer standards. If the synthetic portion contains acid moieties the standards used are typically polyacrylic acid (PAA) standards. The method uses 0.05M sodium phosphate (0.025M NaH₂PO₄ and 0.025M Na₂HPO₄) buffered at pH 7.0 with NaN₃ as the mobile phase. The columns used in this method are: TSKgel PW×1 Guard column, TSKgel; G6000PW×1, G4000PW×1, G3000PW×1, G2500PW×1 set at a temperature of 32° C. Flow rate is 1 mL per minute, and the injection volume is 450 μL. The instrument is calibrated using five different polymer standards injected at five different concentrations: PAA1K (2.0 mg/mL), PAASK (1.75 mg/mL), PAA85K (1.25 mg/mL), PAA495K (0.75 mg/mL), and PAA1700K (0.2 mg/mL), all from American Polymer Standards Corporation.

Molecular weight of starting polysaccharides used in preparing the manufactured polymers described herein can be determined by aqueous Gel Permeation Chromatography (GPC) using a series of hydroxyethyl (HETA) starch standards. The method uses 0.05M sodium phosphate (0.025M NaH₂PO₄ and 0.025M Na₂HPO₄) buffered at pH 7/0 with NaN₃ as the mobile phase. The columns used in this method are: TSKgel PW×1 Guard column, TSKgel; G6000PW×1, G4000PW×1, G3000PW×1, and G2500PW×1 set at a temperature of 32° C. The flow rate is 1 mL/min and injection volume is 450 μL. The instrument is calibrated using five different hydroxyethyl starch standards injected at five different concentrations: HETA10K (2.0 mg/mL), HETA17K (1.75 mg/mL), HETA40K (1.25 mg/mL), HETA95K (0.75 mg/mL), and HETA205K (0.2 mg/mL), all from American Polymer Standards Corporation.

In one embodiment, the manufactured polymer is a graft dendrite copolymer. Known polymer precursors of this type are described, for example, in U.S. Pat. No. 9,051,406, the entire contents of which are hereby incorporated herein by reference. The present disclosure extends to any of the polymers described therein modified by the techniques described herein to substantially eliminate aldehyde functionality in an end group saccharide moiety.

In one embodiment, the manufactured polymer is a hybrid dendrite copolymer. Known polymer precursors of this type are described, for example, in U.S. Pat. No. 9,988,526, the entire contents of which are hereby incorporated herein by reference. The present disclosure extends to any of the polymers described therein modified by the techniques described herein to substantially eliminate aldehyde functionality in an end group saccharide moiety.

In one particular embodiment, the manufactured polymer comprises the following generic structure:

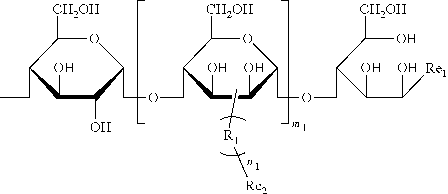

wherein
Re₁ represents a non-aldehyde functionality, preferably an alcohol or a carboxylic acid;
m₁ represents the number of repeat units of the natural component and ranges from, −1-98, preferably 0-48, most preferably 1-10;
n₁ represents the number of repeat units of the synthetic portion and ranges from 20-100, preferably 25-70, most preferably 30-50;
R₁ is an individual monomer residue making up the synthetic portion, but can vary over the chain of (R₁)n₁ groups and is preferably a (meth)acrylic acid monomer, itaconic acid monomer, maleic acid monomer, or a mixture of two or more of the foregoing; and
Re₂ represents a terminal functionality derived from the initiator fragment or from a chain transfer reaction.

The bonding of R₁ to the polysaccharide chain is via covalent carbon-carbon bonding, typically via one of the carbon atoms of the polysaccharide that has a hydroxyl group, most preferably the C₂ or C₃ C of the anhydroglucose unit.

In a preferred embodiment, Re₂ represents H, hydroxyl, sulfate or ORe₄, where Re₄ is a C₁-C₁₀ aliphatic or aromatic moiety derived from a fragment of the initiator. Re₂ is preferably H or a sulfate group. Re₂ represents H will result when, for example, the chain transfers to another monomer or polysaccharide. Re₂ represents OH will result when, for example, the initiator is hydrogen peroxide; and ORe₄ when, for example, the initiator is an organic peroxide. Finally, Re₂ represents sulfate will result when the initiator system is a persulfate. The foregoing are merely exemplary and other terminal functionalities are contemplated and form a part of the present disclosure.

Manufactured polymers corresponding to the foregoing generic structure are particularly well-suited for use as dispersants or scale inhibitors. As noted above, m₁ is the number of saccharide repeat units of the natural component. The degree of polymerization DP₁ is m₁+2. Accordingly, in another embodiment, the DP₁ varies from 1-100, 2-50 and 3-20 for the dispersant or scale inhibitor.

In one embodiment, the polymer comprises mixtures of chains having the foregoing generic structure, and in some cases some chains having Re₁=aldehyde functionality are present, i.e., the treatment in accordance with the methods described herein has not completely eliminated the aldehyde functionality although it has been significantly eliminated.

In one embodiment, the mole % of aldehyde in Re₁ is less than 10 mole % of the number of saccharide units, preferably less than 5 mole % of the number of saccharide units, preferably less than 2 mole % of the number of saccharide units, preferably less than 1.5 mole % of the number of saccharide units, more preferably less than 1.0 mole % of the number of saccharide units and most preferably not present.

In another particular embodiment, the manufactured polymer comprises the following generic structure:

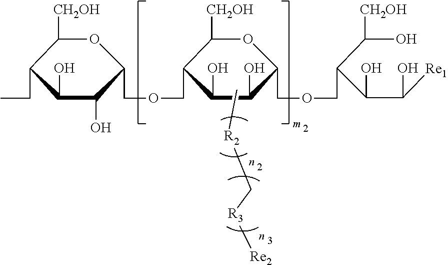

wherein
Re₁ represents a non-aldehyde functionality, preferably an alcohol or a carboxylic acid;
m₂ represents the number of repeat units of the natural component and ranges from 0-9998, preferably 1-998, most preferably 2-98;
n₂ represents a number of repeat units making up a portion of the synthetic portion and is preferably greater than 1000, more preferably greater than 5000 and most preferably greater than 10,000;
R₂ is an individual monomer residue making up the synthetic portion, but can vary over the chain of (R₂)n₂ groups and is preferably derived from an anionic ethylenically unsaturated monomer and is preferably a (meth)acrylic acid monomer;
n₃ represents a number of repeat units making up a portion of the synthetic portion and is preferably greater than 1000, more preferably greater than 5000 and most preferably greater than 10,000;
R₃ is an individual monomer residue making up the synthetic portion, but can vary over the chain of (R₃)n₃ groups and is preferably derived from a hydrophobic ethylenically unsaturated monomer and is preferably an ethyl acrylate, methyl (meth)acrylate or butyl(meth)acrylate monomer, or a mixture of two or more of the foregoing; and
Re₂ represents a terminal functionality derived from the initiator fragment or from a chain transfer reaction, preferably H or a sulfate group.

Manufactured polymer corresponding to this generic structure are particularly well-suited for use as rheology modifiers. As noted above, m₂ is the number of saccharide repeat units of the natural component and the degree of polymerization DP₁ is m₂+2. Accordingly, in another embodiment, the DP₂ varies from 2-10,000, 3-1,000 and 4-100 for the rheology modifier.

In one embodiment, the polymer comprises mixtures of chains having the foregoing generic structure, and in some cases some chains having Re₁=aldehyde functionality are present, i.e., the treatment in accordance with the methods described herein has not completely eliminated the aldehyde functionality although it has been significantly eliminated.

In one embodiment, the mole % of aldehyde in Re₁ is less than 10 mole % of the number of saccharide units, preferably less than 5 mole % of the number of saccharide units, preferably less than 2 mole % of the number of saccharide units, preferably less than 1.5 mole % of the number of saccharide units, more preferably less than 1.0 mole % of the number of saccharide units and most preferably not present.

In yet another embodiment, the manufactured polymer comprises the following generic structure:

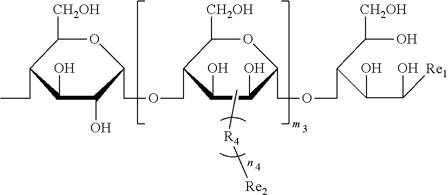

wherein
Re₁ represents an aldehyde, alcohol or a carboxylic acid functionality;
m₃ represents the number of repeat units of the natural component and ranges from, −1 to 98, preferably 0-48, most preferably 1-10;
n₄ represents the number of repeat units of the synthetic portion and ranges from 20-100, preferably 25-70, most preferably 30-50;
R₄ is an individual monomer residue making up the synthetic portion, but can vary over the chain of (R₄)n₃ groups and is preferably a (meth)acrylic acid monomer, itaconic acid monomer, maleic acid monomer, or a mixture of two or more of the foregoing; and
Re₂ represents a terminal functionality derived from the initiator fragment or from a chain transfer reaction, preferably H or a sulfate group.

Manufactured polymers having a narrowed oligosaccharide distribution corresponding to the foregoing generic structure are particularly well-suited for use as dispersants or scale inhibitors. As noted above, m₃ is the number of saccharide repeat units of the natural component. The degree of polymerization DP₃ is m₃+2. Accordingly, in another embodiment, the DP₃ varies from 1-100, preferably 2-50 and most preferably 3-20 for the dispersant or scale inhibitor and is an oligosaccharide having an oligomeric degree of polymerization (DP) wherein a sum of DP1+DP2 is less than 30% and a sum of DP4+DP5+DP6 is greater than 15% of the total oligosaccharide or polysaccharide. DPn represents the number of repeat units n in that particular oligosaccharide chain which DP1 being 1 repeat unit and DP6 being 6 repeat units.

The polymerization of the manufactured polymer will need to be modified by the inventive techniques as hereinbelow described in order to substantially eliminate aldehyde functionality in an end group saccharide moiety. In one embodiment, hydrogenated starch hydrolysates also known as polyols can be used in these reactions. These materials have a minimal amount of aldehyde end groups or do not have any aldehyde groups at all. However, it is possible to generate aldehyde end-groups during the hybrid polymerization process. For example, if the initiator feed lasts much longer than monomer feed, this excess initiator can depolymerize the saccharide chains leading to generation of aldehyde end groups during the polymerization process. To minimize this, the initiator feed should be shorter than the monomer feed when these polyols are used as exemplified in Examples 1-5. One skilled in the art will recognize that these initiators have a half-life at the polymerization temperatures, and it is important to ensure that the initiator feed takes in to account the initiator half-life. The initiator feed and initiator concentration compared to the monomer concentration should be such that there is enough initiator to polymerize the monomer (especially at the end of the monomer feed) but not too much to depolymerize the oligo or polysaccharide after the monomer has been polymerized as exemplified in Examples 1-5. In one embodiment, regular oligosaccharides and polysaccharides such as corn syrups and maltodextrins may be used and the aldehyde end groups can be eliminated at the end of the reaction by treatment with sodium borohydride (as exemplified in Examples 10-12) or hydrogenation (as exemplified in Example 24) of the aldehyde groups to form alcohol end groups. In one embodiment, regular oligosaccharides and polysaccharides such as corn syrups and maltodextrins may be used and the aldehyde end groups can be eliminated at the end of the reaction by oxidation of the aldehyde groups to form carboxylic acid end groups.

Such manufactured polymers such as hybrid copolymers or graft copolymers can be prepared in manners now well known to persons skilled in the art, for example, from at least one hydrophilic acid monomer as the synthetic constituent. Examples of such hydrophilic acid monomers include but are not limited to acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, sodium methallyl sulfonate, sulfonated styrene, allyloxybenzene sulfonic acid and maleic acid. Moieties such as maleic anhydride or acrylamide that can be derivatized to an acid containing group can be used. Combinations of acid-containing hydrophilic monomers can also be used. In one aspect the acid-containing hydrophilic monomer is acrylic acid, maleic acid, itaconic acid, methacrylic acid, 2-acrylamido-2-methyl propane sulfonic acid, or mixtures thereof.

In a preferred embodiment, the manufactured polymer does not contain polyacrylamide.

In addition to the hydrophilic monomers described above, hydrophobic monomers can also be used as the synthetic constituent. These hydrophobic monomers include, for example, ethylenically unsaturated monomers with saturated or unsaturated alkyl, hydroxyalkyl, alkylalkoxy groups, arylalkoxy, alkarylalkoxy, aryl and aryl-alkyl groups, alkyl sulfonate, aryl sulfonate, siloxane, and combinations thereof. Examples of hydrophobic monomers include styrene, α-methyl styrene, methyl methacrylate, methyl acrylate, 2-ethylhexyl acrylate, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, octyl acrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenyl butyl) styrene. Combinations of hydrophobic monomers can also be used.

The polymerization process can be a solution, dispersion or self-stabilized emulsion or suspension process. The process involves polymerization using free radical initiators with one or more of the above hydrophilic and/or hydrophobic monomers, and the hydroxyl containing natural products (e.g., a monosaccharide, oligosaccharide, or polysaccharide, such as a sugar, maltodextrin, or starch) used as chain transfer agents or chain stoppers. These chain transfer agents can be added either at the beginning of the reaction or during reaction as the monomer(s) is (are) added.

Polysaccharides useful in the present disclosure (i.e., in this embodiment and in other embodiments) can be derived from plant, animal and microbial sources. Examples of such polysaccharide sources include starch, cellulose, gums (e.g., gum arabic, guar and xanthan), alginates, pectin and gellan. Starches include those derived from maize and conventional hybrids of maize, such as waxy maize and high amylose (i.e., greater than 40% amylose) maize, as well as other starches such as potato, tapioca, wheat, rice, pea, sago, oat, barley, rye, and amaranth, including conventional hybrids or genetically engineered materials. Also included are hemicellulose or plant cell wall polysaccharides such as D-xylans. Examples of plant cell wall polysaccharides include arabino-xylans such as corn fiber gum, a component of corn fiber.

In one embodiment, useful polysaccharides are water soluble. This implies that the polysaccharides either have a molecular weight low enough to be water soluble, or can be hydrolyzed in situ during the reaction to become water soluble. For example, non-degraded starches are not water soluble. However, degraded starches are water soluble and can be used.

Hydroxyl-containing natural materials (monosaccharides, oligosaccharides and polysaccharides) can be degraded oxidatively, hydrolytically or enzymatically. Generally speaking, degraded polysaccharides according to the present disclosure can have a number average molecular weight (Mn) of about 100,000 or less. In one aspect, the number average molecular weight of the hybrid copolymer is about 25,000 or less. In another aspect, the degraded polysaccharides have a number average molecular weight of about 10,000 or less.

These monosaccharides, oligosaccharides and polysaccharides can optionally be chemically modified. Chemically modified derivatives include carboxylates, sulfonates, phosphates, phosphonates, aldehydes, silanes, alkyl glycosides, alkyl-hydroxyalkyls, carboxy-alkyl ethers and other derivatives. The polysaccharide can be chemically modified before, during or after the polymerization reaction.

Oligosaccharides useful in the present disclosure include corn syrups. Corn syrups are defined as degraded starch products having a DE of 27 to 95. Examples of specialty corn syrups include high fructose corn syrup and high maltose corn syrup. Monosaccharides and disaccharides such as galactose, mannose, sucrose, maltose, ribose, trehalose and lactose can also be used.

Other polysaccharides useful in this disclosure include maltodextrins, which are polymers having D-glucose units linked primarily by α-1,4 bonds and a dextrose equivalent (“DE”) of less than about 20. Maltodextrins are available as a white powder or concentrated solution and are prepared by the partial hydrolysis of starch with acid and/or enzymes. Maltodextrins typically have a distribution of chain lengths, depending upon the number of anhydrous glucose repeat units. The number of repeat units can vary from 1 to greater than 10. (For example, a DE of about 20 would have approximately 5 repeat units, a DE of 100 is equivalent to about 1 repeat unit, and a DE of 1 is equivalent to about 100 repeat units.) In maltodextrins, the larger weight fraction of a sample has greater than 10 anhydroglucose repeat units. Therefore, by convention maltodextrins are considered to be a polysaccharide, even though they may have components that fall under the oligosaccharide definition.

Polysaccharides useful in the present disclosure further include pyrodextrins. Pyrodextrins are made by heating acidified, commercially dry starch to a high temperature. Extensive degradation occurs initially due to the usual moisture present in starch. However, unlike the above reactions that are done in aqueous solution, pyrodextrins are formed by heating powders. As moisture is driven off by the heating, hydrolysis stops, and recombination of hydrolyzed starch fragments occur. This recombination reaction makes these materials distinct from maltodextrins, which are hydrolyzed starch fragments. The resulting pyrodextrin product also has much lower reducing sugar content, as well as color and a distinct odor.

Polysaccharides can be modified or derivatized by etherification (e.g., via treatment with propylene oxide, ethylene oxide, 2,3-epoxypropyl trimethyl ammonium chloride), esterification (e.g., via reaction with acetic anhydride, octenyl succinic anhydride (‘OSA’)), acid hydrolysis, dextrinization, oxidation or enzyme treatment (e.g., starch modified with α-amylase, β-amylase, pullanase, isoamylase or glucoamylase), or various combinations of these treatments. These treatments can be performed before or after the polymerization process.

The natural component can range in weight from 10 to 98 weight percent of the total weight of the copolymer. In one embodiment, the natural component ranges from 20 to 95 percent by weight of total weight of copolymer. In another embodiment, the natural component ranges from 25 to 90 percent by weight of total weight of copolymer. In another embodiment, the natural component ranges from 30 to 85 percent by weight of total weight of copolymer. In another embodiment, the natural component ranges from 35 to 80 percent by weight of total weight of copolymer.

Manufactured polymers are either hybrid polymers or graft polymers and differ mainly in their initiating systems. Hybrid polymers are synthesized using “Hybrid initiators” are free radical initiators or initiating system excluding metal ion based initiators or initiating systems. While not being bound by theory, the hybrid initiators preferably are not free radical abstractors but promote chain transfer. Furthermore, in an embodiment of the disclosure, the hybrid initiator is water soluble. Exemplary hybrid initiators include, but are not limited to, peroxides, azo initiators as well as redox systems like tert-butyl hydroperoxide and erythorbic acid, peroxide such as persulfate and an amine such as hydroxylamine sulfate, persulfate and sodium formaldehyde sulfoxylate etc. The hybrid initiators may include both inorganic and organic peroxides. Suitable inorganic peroxides include sodium persulfate, potassium persulfate and ammonium persulfate. Azo initiators, such as water soluble azo initiators, may also be suitable hybrid initiators. Inorganic peroxides such as persulfates are the preferred initiating system for Hybrid polymers.

The initiator or initiator system used to produce graft copolymers are typically redox systems of a metal ion and hydrogen peroxide. These initiating systems will extract a proton from the natural hydroxyl containing component promoting the grafting reaction. In another aspect, the graft copolymers are made using redox free radical initiating systems such as a metal iron and a peroxide. Metal ions include but are not limited to iron, copper, vanadium etc which are capable of forming a redox system with the peroxide. Peroxides include but are not limited to hydrogen peroxide, inorganic peroxides such as persulfates and combinations thereof; see, Würzburg, O. B., Modified Starches: Properties and Uses, Grafted Starches, Chpt. 10, pp. 149-72, CRC Press, Boca Raton (1986)). Other initiating systems include ceric ammonium nitrate. While not being bound by theory, Graft copolymers are produced by selectively generating initiation sites (e.g., free radicals) for the growth of monomer side chains from an existing polymer backbone (Concise Encyclopedia of Polymer Science and Engineering, J. I. Kroschwitz, ed., Wiley-Interscience, New York, p. 436 (1990). The preferred initiating system for graft copolymers is iron and hydrogen peroxide and iron and a mixture of hydrogen peroxide and persulfate.

The manufactured polymers are substantially free of phosphorous moieties. These phosphorus moieties cause eutrophication of water bodies such as lakes, rivers and oceans and are not preferred. Accordingly, in one embodiment, the manufactured polymers are completely free of phosphorus moieties. In another embodiment, phosphorus is not present in any of the starting materials used to prepare the manufactured polymers and/or is not a component of any reagent used in any process used to prepare the manufactured polymers, nor is it a component of any additive combined with or used to further process the manufactured polymers post-polymerization. Thus, for example, in an embodiment, water-soluble phosphorus compounds, such as phosphorus acid or its salts, are not to be added to the polymer for the purposes of color stabilization or for any other reason.

In still yet another aspect, the disclosure relates to a blend of a manufactured polymer and a builder or a chelating agent. Exemplary chelating agents suitable for use in the present disclosure include, but are not limited to, alkali metal or alkali-metal earth carbonates, alkali metal or alkali earth citrates, alkali metal or alkali earth silicates, glutamic acid N,N-diacetic acid (GLDA), methylglycine N,N-diacetic acid (MGDA) and combinations thereof. In an embodiment according to the disclosure, the blend may be a particulate containing a uniform dispersion of the manufactured polymer and the builder or chelating agent. The particulate may also be a powder or a granule.

In still yet another aspect, the disclosure relates to a manufactured polymer containing both anionic and cationic groups, thus rendering the manufacture of polymer amphoteric. The anionic moieties can be on the naturally derived hydroxyl containing chain transfer agent with the cationic moieties on the synthetic component or the cationic moieties can be on the naturally derived hydroxyl containing chain transfer agent with the anionic moieties on the synthetic component or combinations thereof. When the natural component is a polysaccharide, the anionic material can be an oxidized starch and the cationic moiety can be derived from cationic ethylenically unsaturated monomers such as diallyldimethylammonium chloride. Alternatively, the oxidized starch itself may first be reacted with cationic substituent such as 3-chloro-2-hydroxypropyl) trimethylammonium chloride and then reacted with a synthetic anionic or cationic monomer or mixtures thereof. In another embodiment, a cationic starch may be reacted with an anionic monomer. Finally, the cationic and anionic moieties may be on the synthetic component of these polymers in which case one monomer would be anionic and the other monomer would be cationic. These manufactured polymers are particularly useful in hard surface cleaning applications. It is understood that these polymers will contain both a natural component and a synthetic component. The cationic moieties are preferably present in the range of 0.001 to 40 mole % of the anionic moieties, more preferably the cationic moieties are present in the range of 0.01 to 20 mole % of the anionic moieties, and most preferably the cationic moieties are present in the range of 0.1 to 10 mole % of the anionic moieties.

In another aspect, this aspect of the present disclosure relates to manufactured polymer that contain at least one non-anionic ethylenically unsaturated monomer. As used herein, non-anionic ethylenically unsaturated monomers include those that are not anionic. That is, these non-anionic ethylenically unsaturated monomers may include, but are not limited to, cationic ethylenically unsaturated monomers, nonionic ethylenically unsaturated monomers, amphoteric ethylenically unsaturated monomers and zwitterionic ethylenically unsaturated monomers and mixtures thereof. A manufactured polymer, as used herein, comprises a synthetic polymer produced from at least one cationic ethylenically unsaturated monomer or at least one nonionic ethylenically unsaturated monomer grafted on to a natural hydroxyl containing component.

As used herein, the term “cationic ethylenically unsaturated monomer” means an ethylenically unsaturated monomer which is capable of introducing a positive charge to the non-anionic graft copolymer composition. Examples of cationic monomers include, but are not limited to, acrylamidopropyltrimethyl ammonium chloride (APTAC), methacrylamidopropyltrimethyl ammonium chloride (MAPTAC), diallyldimethyl ammonium chloride (DADMAC), acryloyloxyethyl trimethyl ammonium chloride (AETAC), methacryloyloxyethyl trimethyl ammonium chloride. In an embodiment of the present disclosure, the cationic ethylenically unsaturated monomer has at least one amine functionality. Cationic derivatives of these non-anionic graft dendrite copolymers may be formed by forming amine salts of all or a portion of the amine functionality, by quaternizing all or a portion of the amine functionality to form quaternary ammonium salts, or by oxidizing all or a portion of the amine functionality to form N-oxide groups.

As used herein, the term “amine salt” means the nitrogen atom of the amine functionality is covalently bonded to from one to three organic groups and is associated with an anion.

As used herein, the term “quaternary ammonium salt” means that a nitrogen atom of the amine functionality is covalently bonded to four organic groups and is associated with an anion. These cationic derivatives can be synthesized by functionalizing the monomer before polymerization or by functionalizing the polymer after polymerization. These cationic ethylenically unsaturated monomers include, but are not limited to, N,N dialkylaminoalkyl(meth)acrylate, N,N dialkylaminoalkylacrylate, N-alkylaminoalkyl(meth)acrylate, N,N dialkylaminoalkylacrylamide N,N dialkylaminoalkyl(meth)acrylamide and N-alkylaminoalkyl(meth)acrylamide, where the alkyl groups are independently C₁₋₁₈ cyclic compounds such as 1-vinyl imidazole and the like. Aromatic amine containing monomers, such as vinyl pyridine may also be used. Furthermore, monomers such as vinyl formamide, vinyl acetamide and the like which generate amine moieties on hydrolysis may also be used. Preferably the cationic ethylenically unsaturated monomer is N,N-dimethylaminoethyl methacrylate, tert-butylaminoethylmethacrylate and N,N-dimethylaminopropyl methacrylamide. In an embodiment of the disclosure, the amine monomer is chosen from N,N-dimethylaminoethyl methacrylate, N,N-dimethylaminopropyl methacrylamide, and N,N-diethylaminoethyl methacrylate. In an embodiment, the vinyl pyridine and other amine monomers can be oxidized or quaternized.

In a preferred embodiment, the manufactured polymers do not contain monomers such as vinyl formamide, vinyl acetamide and the like which generate primary amine moieties on hydrolysis.

Cationic ethylenically unsaturated monomers that may be used are the quaternized derivatives of the above monomers as well as diallyldimethylammonium chloride also known as dimethyldiallylammonium chloride, (meth)acrylamidopropyl trimethylammonium chloride, 2-(meth)acryloyloxy ethyl trimethyl ammonium chloride, 2-(meth)acryloyloxy ethyl trimethyl ammonium methyl sulfate, 2-(meth)acryloyloxyethyltrimethyl ammonium chloride, N,N-Dimethylaminoethyl (meth)acrylate methyl chloride quaternary, methacryloyloxy ethyl betaine as well as other betaines and sulfobetaines, 2-(meth)acryloyloxy ethyl dimethyl ammonium hydrochloride, 3-(meth)acryloyloxy ethyl dimethyl ammonium hydroacetate, 2-(meth)acryloyloxy ethyl dimethyl cetyl ammonium chloride, 2-(meth)acryloyloxy ethyl diphenyl ammonium chloride and others. In an embodiment, cationic ethylenically unsaturated monomers suitable for use in the present disclosure are the quaternized derivatives of N,N dialkylaminoalkyl(meth)acrylate, N,N dialkylamino alkylacrylate, N,N dialkylaminoalkylacrylamide and N,N dialkylaminoalkyl(meth)acrylamide, One skilled in the art will recognize that these can be quaternized with methyl chloride (as mentioned above), but they may also be quaternized with dimethylsulfate, diethyl sulfate, ethyl chloride and benzyl chloride and other quaternizing agents.

As used herein, the term “nonionic ethylenically unsaturated monomer” means an ethylenically unsaturated monomer which does not introduce a charge into the manufactured polymer . These nonionic ethylenically unsaturated monomers include, but are not limited to, C₁-C₆ alkyl esters of (meth)acrylic acid and the alkali or alkaline earth metal or ammonium salts thereof, acrylamide and the C₁-C₆ alkyl-substituted acrylamides, the N-alkyl-substituted acrylamides and the N-alkanol-substituted acrylamides, hydroxyl alkyl acrylates and acrylamides. Also suitable are the C₁-C₆ alkyl esters and C₁-C₆ alkyl half-esters of unsaturated vinylic acids, such as maleic acid and itaconic acid, and C₁-C₆ alkyl esters of saturated aliphatic monocarboxylic acids, such as acetic acid, propionic acid and valeric acid. In embodiment, the nonionic ethylenically unsaturated monomer is chosen from acrylamide, methacrylamide, N alkyl(meth)acrylamide, N,N dialkyl(meth)acrylamide such as N,N dimethylacrylamide, hydroxyalkyl(meth)acrylates, alkyl(meth)acrylates such as methylacrylate and methylmethacrylate, vinyl acetate, vinyl morpholine, vinyl pyrrolidone, vinyl caprolactam, ethoxylated alkyl, alkaryl or aryl monomers such as methoxypolyethylene glycol (meth)acrylate, allyl glycidyl ether, allyl alcohol, glycerol (meth)acrylate, monomers containing silane, silanol and siloxane functionalities and others. The nonionic ethylenically unsaturated monomer is preferably water soluble. In a further embodiment, the nonionic ethylenically unsaturated monomer is chosen from acrylamide, methacrylamide, N methyl(meth)acrylamide, N,N dimethyl(meth)acrylamide, methyl methacrylate, methyl acrylate, hydroxyethyl (meth)acrylate and hydroxypropyl (meth)acrylate, N,N dimethylacrylamide, N,N diethylacrylamide, N-isopropylacrylamide and acryloyl morpholin vinyl pyrrolidone and vinyl caprolactam.

### Enzyme-Degraded Starch

In an embodiment, the polymer precursor mixture comprises enzyme-degraded starch. In a preferred embodiment, degrading starch or starch derivatives by alpha-amylase enzyme to its alpha limit leads to digestion of the polysaccharide at regular intervals, producing a narrow range of digested fragments. Enzyme degradation maximizes the oligomeric degree of polymerization (DP) or number of repeat units 4, 5, 6 content while minimizing the DP 1 and 2 content for increased anti-redisposition performance (as shown in Example 39) and carbonate inhibition performance (as shown in Example 40) when used in the hybrid reactions.

The enzyme degraded starches preferably have a sum of DP 1 and DP 2 less than 30 more preferably less than 25, more preferably less than 20 and most preferably less than 16, and a preferably a sum of DP 4, 5 and 6 greater than 15, more preferably greater than 25, more preferably greater than 30 and most preferably greater than 35.

When these digested fragments are, in turn, introduced to the polymer precursor mixture, they are incorporated into the manufactured polymer in the subsequent polymerization. Hybrid polymers incorporating the enzyme degraded polysaccharides with the particular distribution properties described above impart performance advantages, including improved anti-redeposition in laundry and improved calcium carbonate inhibition which gives better anti-encrustation in laundry and minimizes filming in automatic dishwash applications.

Most polysaccharides from any source can be degraded in the manner envisioned herein, including waxy maize and dent corn starch, potato starch, wheat starch, sago starch, pea starch, tapioca starch, and maltodextrins of, for example, DE 1 to DE 24, or DE 1 to DE 18, or DE 1 to DE 10, or DE 1 to DE 5.

If raw starch is the starting material, the starch particles may be swollen and broken prior to enzyme degradation through any number of methods known to those skilled in the art, including jet or batch cooking.

Many enzymes are available for use in degrading polysaccharides, including alpha- and beta-amylase, gluco-amylase, and pullulanase, with alpha-amylase being preferred for the present disclosure. Any one of these enzymes can be used alone or in combination with others and the degree of degradation is controlled using techniques known to those skilled in the art. The preferred embodiment utilizes alpha-amylase to produce the alpha-limit dextrin (i.e., material that has undergone full degradation until no further substantial change in molecular weight distribution is obtained).

Degradation is typically performed on a starch dispersion or solution in water, with the concentration of polysaccharide on a dry basis selected as convenient for handling and subsequent polymerization. The reaction temperature is typically between 50 and 100° C., though lower temperatures could be used.

Though the pH of the solution will be adjusted based on the particular enzyme being used, if alpha-amylase is being used, the pH of the dispersion or solution is typically around pH 5.5-6.5. This can be obtained through either adjustment with an acid or base, or a buffer solution can be used.

Calcium may be added to the dispersion or solution, typically in the amount of 50-100 ppm calcium ion on dispersion/solution weight. Those skilled in the art will recognize that the action of some enzymes may benefit from the presence of calcium. The calcium is often present in millimolar quantities and can stabilize the enzyme against heat. In any process involving the enzymatic degradation of starch, considerations should be made to whether calcium in necessary, and in what quantities.

The amount of enzyme dosed to the starch dispersion or solution will depend on the strength of the particular enzyme material and batch being used. The amount of enzyme used and the amount of cooking time in the presence of the enzyme can be varied but is often selected as to be sufficient for enzyme catalyzed hydrolysis to the alpha limit. Sometimes Kilo Novo Units (KNU) are used as a measure of the expected degradation in given conditions with a given amount of starch material. One KNU(T) is the amount of alpha-amylase which, under standard conditions (pH 7.1; 37° C.) dextrinizes 5.26 g starch dry substance (Merck Amylum soluble No. 9947275 or equivalent) per hour.

The action of the enzyme may be stopped by reducing the pH to about pH 5 or below, for example, with an acid. In most of the reactions addition of acrylic acid to start the polymerization reaction will stop the enzyme degradation.

### Aldehyde Elimination

As discussed herein, aldehyde functionality in saccharide end group moieties has been found to lead to color instability of the resulting polymers. We have further found that color stability can be significantly enhanced by eliminating this aldehyde functionality. Any suitable method of doing so is contemplated, provided the elimination does not cause a significant diminution in the end use performance of the manufactured polymers.

In one embodiment, the aldehyde functionality is converted to alcohol functionality by treatment with a suitable reducing agent.

In another embodiment, the aldehyde functionality is converted to alcohol functionality by treatment with sodium borohydride or lithium aluminum hydride or hydrogenation. Hydrogenation is typically reaction with hydrogen in the presence of a catalyst such as nickel, platinum or palladium.

In one embodiment, the aldehyde functionality is converted to carboxyl acid functionality by treatment with a suitable oxidizing agent.

In another embodiment, the aldehyde functionality is converted to carboxyl functionality by oxidation which may involve treatment with hydrogen peroxide, potassium permanganate, potassium chromate. One skilled in the art will recognize that other oxidation agents may be used.

Other ways to eliminate the aldehyde end group include addition of Grignard reagents, aldol condensations, reactions with amines etc. Persons skilled in the art are generally familiar with such methods and would understand how they can be utilized in the context of the present disclosure.

The preferred methods are reduction and oxidation. The most preferred is reduction to an alcohol using sodium borohydride or hydrogenation.

### Color Control During Polymerization

In an embodiment, color is controlled during polymerization by one or a combination of polyols or hydrogenated starch hydrosylates as the natural components, judicious choice of the amount of initiator, and how the initiator is added and/or pH control. These factors are used to minimize the depolymerization of the polyols during the polymerization process to give a benefit of minimizing color development during alkaline storage in formulations which is where most of the color is developed. Additionally, hydrogen peroxide and/or vinyl acetate as a small amount as a comonomer may be used in combination with the other levers mentioned above but these two additions by themselves will have minimal effect on color especially under storage under alkaline conditions. It is important to note that even though the initial color of polymer may be light as evidenced by using some hydrogen peroxide, the color under alkaline storage conditions may darken when hydrogen peroxide alone is used. The goal is to minimize or eliminate color especially during extended alkaline storage conditions since most of the formulations are in the alkaline region.

The commercially available polyols have extremely low contents and in most cases are free of aldehyde end groups. Therefore, it is important to minimize or eliminate the depolymerization of polyols during the polymerization reaction since this generates aldehyde end groups. This is accomplished by controlling the pH during the polymerization in combination with the initiator control. A pH below 3.5 or 4 causes depolymerization of the polyols during the reaction. An alkaline pH may start the Maillard reaction which darkens the product while it is polymerized and is not preferred. The preferred pH range for polymerization is between 3.5 and 8 and preferably 4.5 and 7.5 and most preferably 4 to 7. This pH is maintained by slow feeding a neutralizing agent such as sodium hydroxide, potassium hydroxide, magnesium hydroxide, calcium hydroxide and mixtures thereof, optionally concurrently with the monomer feed. Controlling the amount of initiator and the time that it is fed compared to the monomers is also critical to minimizing the polyol depolymerization while ensuring that the monomer is polymerized. This is demonstrated by lowering the amount of persulfate initiator in Example 1 as exemplified in Examples 2, 3 and 4 the color is further lowered proportional to the decrease in persulfate initiator as shown in the alkaline ageing test in Example 5. The lowering of the initiator and shortening the time it is added compared to the monomer leads to minimizing the depolymerization of the polyols which generates additional aldehyde end groups especially when the initiator is added past the monomer feed or is present due to a long half-life at reaction temperature. One skilled in the art will recognize that temperature of the reaction plays an important role. The initiator needs to be present at the end of the monomer feed and that is determined by the half-life of the initiator at that temperature. The initiator feed can be shortened to ensure conversion of the monomer and minimize any excess initiator after all the monomer is converted to polymer since this excess initiator may then depolymerize the polyol. The color of the solution of Example 4 is approximately one order of magnitude lower than the color of the solution of Example 1 and approximately two orders of magnitude lower than the color of the solution of Comparative Example 1. These examples indicate that the initiator feed can be controlled to minimize depolymerization of the polyol while ensuring that the monomers are polymerized as indicated by the conversion of the monomer in these samples.

In addition, hydrogen peroxide can be included in the initial reactor charge and/or in the slow initiator feed or as a post treatment since it may oxidize some color impurities in the system. However, hydrogen peroxide in the presence of metal ions such as iron (Fe) is not recommended since these generate extremely reactive hydroxy free radicals. These hydroxy free radicals are very active and good for polymerizing sluggish monomers such as maleic acid. However, they have the disadvantage of strongly depolymerizing the polyols and generating a lot of aldehyde end groups during the polymerization which defeats the purpose of using the expensive polyols. In one embodiment, the hydrogen peroxide is included in the initial reactor charge only. In this embodiment, the amount of hydrogen peroxide ranges from 1 to 10 weight percent based on the total mass of polysaccharide and water present in the initial charge, preferably between 1.5 and 8 weight percent, and most preferably between 2 and 5 weight percent. In another embodiment, the hydrogen peroxide is included in the slow initiator feed only. In this embodiment, the amount of hydrogen peroxide ranges from 1 to 12 weight percent based on the mass of polysaccharide used, preferably 1.5 to 10 weight percent, and most preferably from 2 to 8 weight percent. In yet another embodiment, the hydrogen peroxide is included both in the initial reactor charge and the slow initiator feed. In this embodiment, the hydrogen peroxide introduced in the initial reactor charge ranges from 1 to 10 weight percent based on the total mass of polysaccharide and water present in the initial charge, preferably between 1.5 and 8 weight percent, and most preferably between 1.8 and 5 weight percent; and the content of hydrogen peroxide introduced in the slow initiator feed ranges from 0.01 to 12 weight percent based on the mass of the polysaccharide used, more preferably between 1 and 10 weight percent, and most preferably between 1.5 and 8 weight percent. We have found that it is best to add the hydrogen peroxide after the reactor has reached at least 60° C., preferably at least 20 C, and more preferably at least 35 C in the initial heating process.

Like the hydrogen peroxide above, vinyl acetate has been used to minimize color especially when used in conjunction with polyols, pH control and initiator feed control. We have found that replacing a small amount of the polymer weight (generally less than 5%, preferably less than 2%, most preferably less than 1% of the total monomer is needed) with vinyl acetate has an unexpected positive effect on color maintenance during reaction. For instance, if the polymer is a 50/50 weight percent mix of acrylic acid and polyol, the new polymer would be 48/2/50 acrylic acid/vinyl acetate/polyol on a weight percent basis.

In a preferred embodiment, use of polyols combined with pH control and judicious choice of the amount of initiator, and how the initiator is added is the reaction discoloration-minimizing technique of choice, with addition of hydrogen peroxide and/or inclusion of vinyl acetate being utilized secondary thereto as circumstances require.

### Color Control After Polymerization

If polyols are used during polymerization and proper care is taken to ensure minimum depolymerization during the polymer reaction post treatment may not be necessary but can be include if necessary.

If regular maltodextrins and corn syrups are used in the polymerization reaction, the aldehyde end groups have to be minimized post polymerization. This is done by reducing the aldehyde end groups to an alcohol or oxidizing them to a carboxylic acid. We have found that the reduction to an alcohol is easier to perform. Reduction is typically done by adding a reducing reagent such as sodium borohydride, lithium aluminum hydride, sodium cyanoborohydride and dithionites such as sodium, potassium or zinc dithionite. The preferred reducing agent is sodium borohydride. In addition, the aldehyde end-groups can be reduced by reaction with hydrogen. Reaction with hydrogen is usually in the presence of a metal catalyst such as nickel. When sodium borohydride is used as a reducing agent, the pH of the polymer solution is typically raised to 7-9 and the borohydride is added over 0.5-2 hours at 30-50° C. and the temperature is further maintained with stirring for an additional 1-3 hours. A qualitative color test as illustrated in Example 5 can be performed and if needed, additional borohydride can be added to meet a predetermined alkaline aging color requirement or a certain amount of aldehyde end groups. This is illustrated in Example 46 where the first amount of borohydride added was not enough to give a light enough color in a quick test to simulate alkaline ageing conditions and then additional borohydride was added to meet the needed color specification. The borohydride solution usually contains sodium hydroxide and the final pH of the polymer solution may be high and can be adjusted to a pH range of 7-10 using a suitable acid such as sulfuric acid as exemplified in Example 10-12. Similarly, the reduction can be carried out with hydrogen in the presence of a metal catalyst to a predetermined alkaline aging color requirement or a certain amount of aldehyde end groups as exemplified in Example 24. Typical oxidizing agents such as hydrogen peroxide and periodate may be used to convert the aldehyde end groups to carboxylic acid end groups.

### End Use Applications and Formulations

The manufactured polymers described herein are typically solution polymers which are used to minimize scale and act as dispersants in a variety of end use applications, mainly cleaning applications, laundry, automatic dishwashing, and hard surface cleaning and.

A subset of these molecules are emulsion polymers and can be used as rheology modifiers.

### Cleaning Applications

The manufactured polymers according to the present disclosure can be used in a variety of cleaning formulations. Such formulations include both powdered and liquid laundry formulations such as compact and heavy duty detergents (e.g., builders, surfactants, enzymes, etc.), automatic dishwashing detergent formulations (e.g., builders, surfactants, enzymes, etc.), light-duty liquid dishwashing formulations, rinse aid formulations (e.g., acid, nonionic low foaming surfactants, carrier, etc.) and/or hard surface cleaning formulations (erg., zwitterionic surfactants, germicide, etc.).

The manufactured polymers can be used as viscosity reducers in processing powdered detergents. They can also serve as anti-redeposition agents, dispersants, scale and deposit inhibitors, and crystal modifiers, providing whiteness maintenance in the washing process.

Any suitable adjunct ingredient in any suitable amount can be used in the cleaning formulations described herein. Useful adjunct ingredients include, for example, aesthetic agents, anti-filming agents, anti-redeposition agents, anti-spotting agents, anti-graying agents, beads, binders, bleach activators, bleach catalysts, bleach stabilizing systems, bleaching agents, brighteners, buffering agents, builders, carriers, chelants, clay, color speckles, control release agents, corrosion inhibitors, dish care agents, disinfectant, dispersant agents, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

The cleaning formulations can further include builders, enzymes, surfactants, bleaching agents, bleach modifying materials, carriers, acids, corrosion inhibitors and aesthetic agents. Suitable builders include, but are not limited to, alkali metals, ammonium and alkanol ammonium salts of polyphosphates, alkali metal silicates, alkaline earth and alkali metal carbonates, nitrilotriacetic acids, polycarboxylates, (such as citric acid, mellitic acid, succinic acid, oxydisuccinic acid, polymaleic acid, benzene 1,3,5-tricarboxylic acid, carboxymethyl oxysuccinic acid, and water-soluble salts thereof), phosphates (e.g., sodium tripolyphosphate), and mixtures thereof. Suitable enzymes include, but are not limited to, proteases, amylases, cellulases, lipases, carbohydrases, bleaching enzymes, cutinases, esterases, and wild-type enzymes. Suitable surfactants include, but are not limited to, nonionic surfactants, anionic surfactants, cationic surfactants, ampholytic surfactants, zwitterionic surfactants, and mixtures thereof. Suitable bleaching agents include, but are not limited to, common inorganic/organic chlorine bleach (e.g., sodium or potassium dichloroisocyanurate dihydrate, sodium hypochlorite, sodium hypochloride), hydrogen-peroxide releasing salt (such as, sodium perborate monohydrate (PB1), sodium perborate tetrahydrate (PB4)), sodium percarbonate, sodium peroxide, and mixtures thereof. Suitable bleach-modifying materials include but are not limited to hydrogen peroxide-source bleach activators (e.g., TAED), bleach catalysts (e.g. transition containing cobalt and manganese). Suitable carriers include, but are not limited to: water, low molecular weight organic solvents (e.g., primary alcohols, secondary alcohols, monohydric alcohols, polyols, and mixtures thereof), and mixtures thereof.

Suitable acids include, but are not limited to, acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof. Suitable corrosion inhibitors, include, but are not limited to, soluble metal salts, insoluble metal salts, and mixtures thereof. Suitable metal salts include, but are not limited to, aluminum, zinc (e.g., hydrozincite), magnesium, calcium, lanthanum, tin, gallium, strontium, titanium, and mixtures thereof. Suitable aesthetic agents include, but are not limited to, opacifiers, dyes, pigments, color speckles, beads, brighteners, and mixtures thereof.

With the addition of suitable adjuncts, cleaning formulations described herein can be useful as automatic dishwashing detergent (‘ADD’) compositions (e.g., builders, surfactants, enzymes, etc.), light-duty liquid dishwashing compositions, laundry compositions such as, compact and heavy-duty detergents (e.g., builders, surfactants, enzymes, etc.), rinse aid compositions (e.g., acids, nonionic low-foaming surfactants, carriers, etc.), and/or hard surface cleaning compositions (e.g., zwitterionic surfactants, germicides, etc.).

Suitable adjunct ingredients are disclosed in one or more of the following: U.S. Pat. Nos. 2,798,053; 2,954,347; 2,954,347; 3,308,067; 3,314,891; 3,455,839; 3,629,121; 3,723,322; 3,803,285; 3,929,107, 3,929,678; 3,933,672; 4,133,779, 4,141,841; 4,228,042; 4,239,660; 4,260,529; 4,265,779; 4,374,035; 4,379,080; 4,412,934; 4,483,779; 4,483,780; 4,536,314; 4,539,130; 4,565,647; 4,597,898; 4,606,838; 4,634,551; 4,652,392; 4,671,891; 4,681,592; 4,681,695; 4,681,704; 4,686,063; 4,702,857; 4,968,451; 5,332,528; 5,415,807; 5,435,935; 5,478,503; 5,500,154; 5,565,145; 5,670,475; 5,942,485; 5,952,278; 5,990,065; 6,004,922; 6,008,181; 6,020,303; 6,022,844; 6,069,122; 6,060,299; 6,060,443; 6,093,856; 6,130,194; 6,136,769; 6,143,707; 6,150,322; 6,153,577; 6,194,362; 6,221,825; 6,365,561; 6,372,708; 6,482,994; 6,528,477; 6,573,234; 6,589,926; 6,627,590; 6,645,925; and 6,656,900; International Publication Nos. 00/23548; 00/23549; 00/47708; 01/32816; 01/42408; 91/06637; 92/06162; 93/19038; 93/19146; 94/09099; 95/10591; 95/26393; 98/35002; 98/35003; 98/35004; 98/35005; 98/35006; 99/02663; 99/05082; 99/05084; 99/05241; 99/05242; 99/05243; 99/05244; 99/07656; 99/20726; and 99/27083; European Patent No. 130756; British Publication No. 1137741 A; Chemtech, pp. 30-33 (March 1993); J. American Chemical Soc., 115, 10083-10090 (1993); and Kirk Othmer Encyclopedia of Chemical Technology, 3rd Ed., Vol. 7, pp. 430-447 (John Wiley & Sons, Inc., 1979).

In one embodiment, cleaning formulations according to the present disclosure can include a suitable adjunct ingredient in an amount of from 0% to about 99.99% by weight of the formulation. In another aspect, the cleaning formulations can include from about 0.01% to about 95% by weight of the formulation of a suitable adjunct ingredient. In other various aspects, the cleaning formulations can include from about 0.01% to about 90%, or from about 0.01% to about 80%, or from about 0.01% to about 70%, or from about 0.01% to about 60%, or from about 0.01% to about 50%, or from about 0.01% to about 40%, or from about 0.01% to about 30%, or from about 0.01% to about 20%, or from about 0.01% to about 10%, or from about 0.01% to about 5%, or from about 0.01% to about 4%, or from about 0.01% to about 3%, or from about 0.01% to about 2%, or from about 0.01% to about 1%, or from about 0.01% to about 0.5%, or alternatively from about 0.01% to about 0.1% by weight of the formulation of a suitable adjunct ingredient.

Cleaning formulations can be provided in any suitable physical form. Examples of such forms include solids, granules, powders, liquids, pastes, creams, gels, liquid gels, and combinations thereof. Cleaning formulations used herein include unitized doses in any of a variety of forms, such as tablets, multi-phase tablets, gel packs, capsules, multi-compartment capsules, water-soluble pouches or multi-compartment pouches. Cleaning formulations can be dispensed from any suitable device. Suitable devices include, but are not limited to, wipes, hand mittens, boxes, baskets, bottles (e.g., pourable bottles, pump assisted bottles, squeeze bottles), multi-compartment bottles, jars, paste dispensers, and combinations thereof.

In the case of additive or multi-component products contained in single- and/or multi-compartment pouches, capsules, or bottles, it is not required that the adjunct ingredients or cleaning formulations be in the same physical form. In one non-limiting embodiment, cleaning formulations can be provided in a multi-compartment, water-soluble pouch comprising both solid and liquid or gel components in unit dose form. The use of different forms can allow for controlled release (e.g., delayed, sustained, triggered or slow release) of the cleaning formulation during treatment of a surface (e.g., during one or more wash and/or rinse cycles in an automatic dishwashing machine).

The pH of these formulations can range from 1 to 14 when the formulation is diluted to a 1% solution. Most formulations are neutral or basic, meaning in the pH range of 7 to about 13.5. However, certain formulations can be acidic, meaning a pH range from 1 to about 6.5.

Copolymers according to the present disclosure can also be used in a wide variety of cleaning formulations containing builders. These formulations can be in the form of a powder, liquid or unit doses such as tablets or capsules, and can be used to clean a variety of substrates such as clothes, dishes, and hard surfaces such as bathroom and kitchen surfaces. The formulations can also be used to clean surfaces in industrial and institutional cleaning applications.

In cleaning formulations, the polymer can be diluted in the wash liquor to end use level. The polymers are typically dosed at 0.01 to 1000 ppm in the aqueous wash solutions.

Optional components in detergent formulations include, but are not limited to, ion exchangers, alkalies, anticorrosion materials, anti-redeposition materials, optical brighteners, fragrances, dyes, fillers, chelating agents, enzymes, fabric whiteners and brighteners, sudsing control agents, solvents, hydrotropes, bleaching agents, bleach precursors, buffering agents, soil removal agents, soil release agents, fabric softening agent and opacifiers. These optional components can comprise up to about 90% by weight of the detergent formulation.

Manufactured polymers according to the present disclosure can be incorporated into hand dish, autodish and hard surface cleaning formulations. The polymers can also be incorporated into rinse aid formulations used in autodish formulations. Autodish formulations can contain builders such as phosphates and carbonates, bleaches and bleach activators, and silicates. These polymers can also be used in reduced phosphate formulations (i.e., less than 1500 ppm in the wash) and zero phosphate autodish formulations. In zero-phosphate autodish formulations, removal of the phosphates negatively affects cleaning, as phosphates provide sequestration and calcium carbonate inhibition. Manufactured polymers according to the present disclosure aid in sequestration and threshold inhibition, as well as soil removal and therefore are suitable for use in zero-phosphate autodish formulations. Further, manufactured polymers according to the present disclosure are useful in minimizing spotting and filming in rinse aid compositions for automatic dishwasher applications.

The above formulations can also include other ingredients such as enzymes, buffers, perfumes, anti-foam agents, processing aids, and so forth. Hard surface cleaning formulations can contain other adjunct ingredients and carriers. Examples of adjunct ingredients include, without limitation, buffers, builders, chelants, filler salts, dispersants, enzymes, enzyme boosters, perfumes, thickeners, clays, solvents, surfactants and mixtures thereof.

One skilled in the art will recognize that the amount of polymer(s) required depends upon the cleaning formulation and the benefit they provide to the formulation. In one aspect, use levels can be about 0.01 weight % to about 10 weight % of the cleaning formulation. In another embodiment, use levels can range from about 0.1 weight % to about 2 weight % of the cleaning formulation.

In one embodiment, the cleaning formulation is a dry detergent.

In one embodiment, the cleaning formulation is a liquid detergent.

In one embodiment, the cleaning formulation is an automatic dishwashing detergent.

In one embodiment, the cleaning formulation is phosphate-free.

In one embodiment, the cleaning formulation comprises a phosphate-free builder.

### Rheology Modifiers

In one embodiment, the manufactured polymer is a polysaccharide alkali swellable rheology modifier composition. Known polymer precursors of this type are described, for example, in U.S. Pat. No. 9,963,534, the entire contents of which are hereby incorporated herein by reference. The present disclosure extends to any of the polymers described therein modified by the techniques described herein to substantially eliminate aldehyde functionality in an end group saccharide moiety.

In an embodiment, the disclosure is a polysaccharide alkali swellable rheology modifier composition. The composition comprises a polysaccharide alkali swellable rheology modifier comprising a polysaccharide portion and a synthetic portion obtained from an anionic ethylenically unsaturated monomer, a hydrophobic ethylenically unsaturated monomer and, optionally, an associative monomer, unreacted polysaccharide and water.

In an embodiment of the disclosure, the polymers may be substantially free of surfactants, such as stabilizing surfactants, during the polymerization process. For purposes of this disclosure, in an embodiment, substantially free of surfactants means that the polymers have about 0.1 wt % or less surfactant, in another embodiment, about 0.01 wt % or less surfactant by weight of the polysaccharide and monomers and in yet another embodiment no surfactant is present during the polymerization process. By polymerizing under conditions that minimize the amount of surfactants present, the chances of the monomers reacting with the polysaccharide to form the polysaccharide alkali swellable rheology modifier is increased. In an embodiment of the disclosure, a stabilizing surfactant may be added after the polymerization to stabilize the emulsion composition.

As used herein, the term “anionic ethylenically unsaturated monomer” means an ethylenically unsaturated monomer which is capable of developing a negative charge when the polysaccharide alkali swellable rheology modifier is in an aqueous solution. These anionic ethylenically unsaturated monomers can include, but are not limited to, acrylic acid, methacrylic acid, ethacrylic acid, α-chloro-acrylic acid, α-cyano acrylic acid, β-methyl-acrylic acid (crotonic acid), α-phenyl acrylic acid, β-acryloxy propionic acid, sorbic acid, α-chloro sorbic acid, angelic acid, cinnamic acid, p-chloro cinnamic acid, β-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, muconic acid, 2-acryloxypropionic acid, 2-acrylamido-2-methyl propane sulfonic acid, vinyl sulfonic acid, sodium methallyl sulfonate, sulfonated styrene, allyloxybenzene sulfonic acid, vinyl phosphonic acid and maleic acid. Combinations of anionic ethylenically unsaturated monomers can also be used. In an embodiment of the disclosure, the anionic ethylenically unsaturated monomer may preferably be methacrylic acid, maleic acid, acrylic acid, itaconic acid, 2-acrylamido-2-methyl propane sulfonic acid or mixtures thereof. In an embodiment, most preferably the anionic ethylenically unsaturated monomer is methacrylic acid or acrylic acid, or combinations thereof.

For purposes of the present disclosure, the term “hydrophobic ethylenically unsaturated monomer” means a monomer that is hydrophobic and results in the formation of an emulsion system when reacted with the polysaccharide and the anionic ethylenically unsaturated monomer. For purposes of this disclosure, a hydrophobic monomer is an ethylenically unsaturated monomer defined as any ethylenically unsaturated monomer having a water solubility of less than 3 grams per 100 mls of water at 25° C. and preferably less than 1 gram per 100 mls of water at 25° C. and most preferably less than 0.1 gram per 100 mls of water at 25° C. These hydrophobic monomers may contain linear or branched alk(en)yl, cycloalkyl, aryl, alk(en)aryl moieties. Suitable hydrophobic ethylenically unsaturated monomers include C1-C7 alkyl esters or amides of acrylic and methacrylic acid including ethyl (meth)acrylate, methyl (meth)acrylate, butyl (meth)acrylate, styrene, vinyltoluene, t-butyl styrene, isopropylstyrene, and p-chlorostyrene; vinyl acetate, vinyl butyrate, vinyl caprolate, acrylonitrile, methacrylonitrile, butadiene, isobutylene, isoprene, vinyl chloride, vinylidene chloride, tertiary butyl acrylamide, benzyl (meth)acrylate, phenyl (meth)acrylate, benzyl ethoxylate (meth)acrylate, phenyl ethoxylate (meth)acrylate, 2-ethylhexyl (meth)acrylate, 2-butyloctyl (meth)acrylate, 2-hexyldecyl (meth)acrylate, 2-octyldodecyl (meth)acrylate, 2-decyltetradecyl (meth)acrylate, 2-dodecylhexadecyl (meth)acrylate, isopropyl (meth)acrylate, isobutyl (meth)acrylate, tertiary butyl (meth)acrylate, t-octyl acrylamide, octyl acrylate, lauryl acrylate, stearyl acrylate, behenyl acrylate, 2-ethylhexyl methacrylate, octyl methacrylate, lauryl methacrylate, stearyl methacrylate, behenyl methacrylate, 2-ethylhexyl acrylamide, n-octyl acrylamide, lauryl acrylamide, stearyl acrylamide, behenyl acrylamide, propyl acrylate, butyl acrylate, pentyl acrylate, hexyl acrylate, 1-allyl naphthalene, 2-allyl naphthalene,l-vinyl naphthalene, 2-vinyl naphthalene. and combinations thereof. Preferred are ethyl (meth)acrylate, methyl (meth)acrylate, 2-ethylhexyl acrylate, butyl (meth)acrylate, vinyl acetate, tertiary butyl acrylamide and combinations thereof. In an embodiment, ethyl acrylate, methyl acrylate, vinyl acetate, butyl acrylate and combinations thereof are preferred.

For purposes of the present disclosure, an associative monomer is intended to mean an ethylenically unsaturated monomer containing a hydrophobe and a spacer moiety which allows the hydrophobe to be sufficiently far away from the backbone of the polymer to form hydrophobic associations in aqueous solutions. The spacer moieties are usually ethoxylate groups but any other group that extends the hydrophobe away from the backbone of the polymer may be used. The hydrophobes with a spacer moiety include, but are not limited to, alcohol ethoxylates, alkylphenoxy ethoxylates, propoxylated/butoxylated ethoxylates, ethoxylated silicones and the like. In an embodiment, the preferred hydrophobes with spacer moieties include alcohol ethoxylates and/or alkylphenoxy ethoxylates. In another embodiment, alcohol ethoxylates containing alcohols with carbon chain lengths of 6 to 40 and 6 to 100 moles of ethoxylation are more preferred. In yet another embodiment, alcohol ethoxylates containing alcohols with carbon chain lengths of 12 to 22 and 15 to 30 moles of ethoxylation are particularly preferred. The hydrophobes may be linear or branched alk(en)yl, cycloalkyl, aryl, alk(en)aryl or an alkoxylated derivative. In an embodiment, the most preferred hydrophobes are linear or branched alcohols and amines containing 12 to 32 carbons. The associative monomer may contain an ethylenically unsaturated monomer covalently linked to the hydrophobe. In an embodiment, the ethylenically unsaturated monomer part of the associate monomer preferably is a (meth)acrylate, itaconate and/or maleate which contains ester linking groups. However, the associative monomer may also contain amide, urea, urethane, ether, alkyl, aryl and other suitable linking groups. The hydrophobe may be an alkylamine or dialkylamine ethoxylate. In an embodiment, the (meth)acrylate group is most preferred. In another embodiment, preferred associative monomers are C12-32(EO)10-30 meth(acrylates) or C12-32(EO)10-30 itaconates or C12-32(EO)10-30 maleates. These associative monomers are known to those skilled in the art and any of the known associative monomers can be used as part of this disclosure.

In an embodiment, the minimum weight of the anionic ethylenically unsaturated monomer is about 15 weight percent or more of the total monomer added to the polymerization process, in another embodiment preferably about 20 weight percent or more of the total monomer added to the polymerization process, and in yet another embodiment, most preferably about 30 weight percent or more of the total monomer added in to the polymerization process. In an embodiment, the maximum weight of the anionic ethylenically unsaturated monomer is about 80 weight percent or less of the total monomer added in to the polymerization process, is preferably about 70 weight percent or less of the total monomer added to the polymerization process, and in another embodiment most preferably about 60 weight percent or less of the total monomer added in to the polymerization process.

In an embodiment according to the present disclosure, the minimum amount of hydrophobic ethylenically unsaturated monomer required is an amount effective to form an emulsion, which may depend on the hydrophobicity of the monomer. That is, the higher the hydrophobicity the less monomer would be required to form an emulsion. In an embodiment, the minimum weight of the hydrophobic ethylenically unsaturated monomer effective to form an emulsion is about 10 weight percent or more of the total monomer added to the polymerization process, in another embodiment preferably about 25 weight percent or more of the total monomer added to the polymerization process, and in yet another embodiment most preferably about 40 weight percent or more of the total monomer added to the polymerization process. In an embodiment, the maximum weight of the hydrophobic ethylenically unsaturated monomer is about 95 weight percent or less of the total monomer added to the polymerization process, in another embodiment preferably about 90 weight percent or less of the total monomer added to the polymerization process, and in yet another embodiment most preferably about 80 weight percent or less of the total monomer added to the polymerization process.

In an embodiment, the minimum weight of the associative monomer is about 0.1 weight percent or more of the total monomer added to the polymerization process, in another embodiment preferably about 1 weight percent or more of the total monomer added to the polymerization process, and in yet another embodiment most preferably about 2 weight percent or more of the total monomer added to the polymerization process. In an embodiment, the maximum weight of the associative monomer is about 30 weight percent or less of the total monomer added to the polymerization process, in another embodiment preferably about 25 weight percent or less of the total monomer added to the polymerization process, and in yet another embodiment most preferably about 20 weight percent or less of the total monomer added in to the polymerization process.

It has been found that styrene or substituted styrene do not react well with the polymers of the disclosure and may lead to high residual monomer levels which cause undesirable odors. Accordingly, in an embodiment of the disclosure, if styrene or substituted styrene is included as one part of the hydrophobic ethylenically unsaturated monomer, then the amount of this monomer is preferably about 10 weight percent or less of the total monomer, in another embodiment more preferably about 5 weight percent or less of the total monomer and in yet another embodiment is most preferably about 1 weight percent or less of the total monomer.

In an aspect, the present disclosure is directed to a process for preparing the polysaccharide alkali swellable rheology modifiers. The process comprises dissolving the polysaccharide in water and heating the solution to a temperature sufficient to initiate the reaction. In an embodiment, the temperature sufficient to initiate the reaction is approximately 25° C.-95° C. In an embodiment, the polysaccharide may be depolymerized before or during the polymerization step to a molecular weight that is sufficient to provide a stable emulsion in the end product. In an embodiment, the depolymerization may be accomplished by using free radicals or enzymes or any other process known to those of ordinary skill in the art. In a typical process according to the present disclosure, a mixture of monomers and an aqueous solution of an initiator are added over a period of time. In an embodiment, the monomer may be methacrylic acid mixed with a hydrophobic monomer, such as ethyl acrylate. Optionally, an associative monomer may be added to the monomer mix. After the polymerization is completed, the reaction mixture is then cooked for a period of time sufficient to lower the residual monomer. Additional initiator to scavenge any remaining monomer may then be added. The temperature required depends on the initiating system used and would be known to one skilled in the art. The residual level of each monomer is less than about 1000 ppm of the emulsion polymer composition, more preferably less than about 500 ppm of the emulsion polymer composition, and most preferably less than about 100 ppm of the emulsion polymer composition.

In an embodiment, chain transfer agents and crosslinking agents may be added during the polymerization process. Suitable chain transfer agents include, but are not limited to, mercaptans, such as, for example, dodecylmercaptan, methyl mercaptopropionate, and 3-mercaptopropionic acid, 2-mercaptoethanol, combinations thereof and the like.

Suitable crosslinking agents include, but are not limited to, polyethylenically unsaturated copolymerizable monomers effective for crosslinking, such as, for example, diallylphthalate, divinylbenzene, vinyl crotonate, allyl methacrylate, trimethylol propane triacrylate, ethylene glycol diacrylate or dimethacrylate, polyethylene glycol diacrylate or dimethacrylate, 1,6-hexanediol diacrylate or dimethacrylate, diallyl benzene, combinations thereof, and the like.

The resulting reaction product may be in one or more forms. In an embodiment, the reaction product may be in the form of a stable emulsion composition containing water, the polymers of the disclosure and any unreacted polysaccharide which is a liquid and then ready to use by diluting to the necessary concentration and adding a neutralization agent.

For purposes of this disclosure, a stable emulsion system is defined as comprising the polymers of this disclosure, unreacted polysaccharide and water, in liquid form, with at about 10 weight % or more and preferably about 15 weight % or more and most preferably about 20 weight % or more solids, and in an embodiment the emulsion does not phase separate for approximately 1 month at 25° C. and in another embodiment preferably does not separate for approximately 6 months at 25° C.

The stable emulsion composition may be diluted with water and then neutralized to give viscosity and rheology to the aqueous systems. In one embodiment of the disclosure, the stable emulsion composition is readily dilutable. For purposes of this disclosure, “readily dilutable” means that the emulsion composition can be diluted to about a 1-5 weight %, aqueous polymer solution or dispersion by adding water using stirring and adding a neutralizing agent and heating, if necessary, and more preferably diluted to about a 1-5 weight % aqueous polymer solution or dispersion by adding water and using stirring. After the neutralization agent is added and the pH raised, in an embodiment a pH in the range from about 5 to about 12, in another embodiment from about 5 to about 10 and yet another embodiment from about 7 to about 10, the polymer is dissolved in water and forms a solution, i.e. it is no longer in the dispersed or emulsion phase. This is evidenced by a visual change of a white emulsion to a clear solution. In an embodiment of the disclosure, the stable emulsion composition or the aqueous emulsion paste composition, when diluted to about 2% solids and neutralized to a pH of about 8 with suitable neutralizing agents, generates a viscosity at 25° C. of about 500 cps or more, in another embodiment preferably about 2500 cps or more and in another embodiment more preferably about 5000 cps or more at 10 rpm when measured using a Brookfield viscometer.

In an embodiment, the polysaccharide alkali swellable rheology modifier or polysaccharide hydrophobically modified alkali swellable rheology modifiers include emulsion compositions in the pH range about 2 to about 5. Consequently, these compositions need to be activated by neutralizing with a neutralizing agent. Suitable neutralizing agents which may be included in the composition of the present disclosure include, but are not limited to, alkyl monoamines containing from about 2 to about 22 carbon atoms, such as triethylamine, stearylamine and laurylamine, and amino alcohols such as triethanolamine, 2-amino-2-methyl-1,3-propanediol and 2-amino-2-methyl-1-propanol, and inorganic neutralizing agents, such as sodium hydroxide and potassium hydroxide. Other combinations of useful neutralizing agents are described in U.S. Pat. No. 4,874,604 to Sramek, which is incorporated by reference in its entirety herein. In an embodiment, the neutralizing agents may be used alone or in combination. In an embodiment, the polysaccharide alkali swellable rheology modifier or polysaccharide hydrophobically modified alkali swellable rheology modifiers are neutralized by a base. The neutralizing agent may be present in an amount effective to neutralize a percentage of the polymer's free acid groups and render the polymer water-soluble or water-dispersible. In one embodiment, the neutralizing agent may be present in an amount sufficient to neutralize the free acid groups of the polymer from about 8 percent to about 100 percent neutralization of the total free acid groups of the polymer. In another embodiment, the free acid groups of the polymer may be neutralized from about 25 percent to about 100 percent. In another embodiment, the free acid groups of the polymer may be neutralized from about 50 percent to about100 percent. In yet another embodiment, the free acid groups of the polymer will be neutralized from about 70 percent to about 100 percent. In still yet another embodiment, the free acid groups of the polymer may be neutralized from about 80 to about 100 percent. The base may also be used in excess of 100 percent neutralization to increase the solution pH. In another embodiment, when the final pH range of the aqueous system is desired to be about 5 to about 7, the solution containing the polymers of this disclosure may be neutralized to the pH of about 7 to about 9 and then the pH adjusted back to about 5 to about 7 using a suitable acid. This ensures that the polymers are completely extended and allows for maximum rheology modification performance.

As used herein, the initiating system is any free radical initiating system. In an embodiment, the initiating system is water soluble. Suitable initiators include, but are not limited to, peroxides, azo initiators as well as redox systems, such as tert-butyl hydroperoxide and erythorbic acid, and metal ion based initiating systems. Initiators may also include both inorganic and organic peroxides. In an embodiment, the inorganic peroxides, such as sodium persulfate, potassium persulfate and ammonium persulfate, are preferred. In a further embodiment, the metal ion based initiating systems including Fe and hydrogen peroxide, as well as Fe in combination with other peroxides, are preferred. Azo initiators, especially water soluble azo initiators, may also be used. Water soluble azo initiators include, but are not limited to, 2,2′-Azobis[2-(2-imidazolin-2-yl)propane]dihydrochloride, 2,2′-Azobis[2-(2-imidazolin-2-yl)propane]disulfate dihydrate, 2,2′-Azobis(2-methylpropionamidine)dihydrochloride, 2,2′-Azobis[N-(2-carboxyethyl)-2-methylpropionamidine]hydrate, 2,2′-Azobis{2-[1-(2-hydroxyethyl)-2-imidazolin-2-yl]propane}dihydrochloride, 2,2′-Azobis[2-(2-imidazolin-2-yl)propane], 2,2′-Azobis(1-imino-1-pyrrolidino-2-ethylpropane)dihydrochloride, 2,2′-Azobis{2-methyl-N-[1,1-bis(hydroxymethyl)-2-hydroxyethl]propionamide}, 2,2′-Azobis[2-methyl-N-(2-hydroxyethyl)propionamide] and others. The initiators when added before the monomer can be used to depolymerize the polysaccharide to a desired molecular weight. Furthermore, a different initiating system could be used during the polymerization process. Finally, a third initiating system can be used to scavenge the residual monomer. All 3 of these initiating systems can be same of different. Thus, it is contemplated that in an embodiment of the disclosure, combinations of the initiating systems can also be used.

If persulfate is used in combination with undegraded starch, the persulfate initiator is preferably about 1 weight percent or less of the total weight of the undegraded starch and monomer, and preferably about 0.5 weight percent or less of the total weight of the undegraded starch and monomer and most preferably about 0.1 weight percent or less of the total weight of the undegraded starch and monomer.

In an embodiment, the disclosure relates to a polysaccharide alkali swellable rheology modifier and its use in personal care, fabric and cleaning, oil field, agricultural, adhesive, paint and coatings and other industrial applications. In an embodiment, the polymers of this disclosure may be added to these formulations at least about 0.1% polymer by weight of the formulation, more preferably at least about 0.5% polymer by weight of the formulation and most preferably at least about 1.0% polymer by weight of the formulation. In an embodiment, the polymers of this disclosure may be added to these formulations at most about 20% polymer by weight of the formulation, more preferably at most about 15% polymer by weight of the formulation and most preferably at least about 10% polymer by weight of the formulation.

### Personal Care Applications

The personal care applications include, but are not limited to, formulations for hair styling gels, skin creams, suntan lotions, moisturizers, toothpastes, medical and first aid ointments, cosmetic ointments, suppositories, cleansers, lipstick, mascara, hair dye, cream rinse, shampoos, body soap and deodorants, hair care and styling formulations, shave prep and hand sanitizers including alcohol based hand sanitizers.

Suitable personal care applications also include formulation for use on the skin, eyelashes or eyebrows, including, without limitation, cosmetic compositions such as mascara, facial foundations, eyeliners, lipsticks, and color products; skin care compositions such as moisturizing lotions and creams, skin treatment products, skin protection products in the form of an emulsion, liquid, stick, or a gel; sun care compositions such as sunscreens, sunscreen emulsions, lotions, creams, sunscreen emulsion sprays, liquid/alcohol sunscreen sprays, sunscreen aqueous gels, broad spectrum sunscreens with UVA and UVB actives, sunscreens with organic and inorganic actives, sunscreens with combinations of organic and inorganic actives, suntan products, self-tanning products, and after sun products etc. Particularly suitable compositions are personal care emulsions, more particularly suitable are sun care compositions such as sunscreen emulsions and sunscreen emulsion sprays. The personal care composition may be in any form, including without limitation in sprays, emulsions, lotions, gels, liquids, sticks, waxes, pastes, powders, and creams.

The personal care compositions may also include other optional components commonly used in the industry, and these will vary greatly depending upon the type of composition and the functionality and properties desired. Without limitation, these components include thickeners, suspending agents, emulsifiers, UV filters, sunscreen actives, humectants, moisturizers, emollients, oils, waxes, solvents, chelating agents, vitamins, antioxidants, botanical extracts, silicones, neutralizing agents, preservatives, fragrances, dyes, pigments, conditioners, polymers, antiperspirant active ingredients, antiacne agents, anti-dandruff actives, surfactants, exfoliants, film formers, propellants, tanning accelerator, hair fixatives and colors. The polymers of the present disclosure are compatible with most other components used in conventional personal care compositions. For example, sunscreen compositions may contain at least one component selected from the group comprising organic UV filters, inorganic UV actives, UVA and/or UVB sunscreen actives, octinoxate, octisalate, oxybenzone, homosalate, octocrylene, avobenzene, titanium dioxide, starch, conditioning agents, emulsifiers, other rheology modifiers and thickeners, neutralizers, emollients, solvents, film formers, moisturizers, antioxidants, vitamins, chelating agents, preservatives, fragrances, and zinc oxide. Skin care and cosmetic compositions may contain at least one component selected from the group consisting of vitamins, anti-aging agents, moisturizers, emollients, emulsifiers, surfactants, preservatives, pigments, dyes, colors and insect repellents.

When used in personal care formulations, such as hair care and styling formulations, for example styling gels, optional additional ingredients can be added to provide a variety of further additional properties. Various other additives, such as active and functional ingredients, may be included in the personal care formulation as defined herein. These include, but are not limited to, emollients, humectants, thickening agents surfactants, UV light inhibitors, fixative polymers preservatives pigments dyes, colorants, alpha hydroxy acids, aesthetic enhancers such as starch perfumes and fragrances, film formers (water proofing agents) antiseptics, antifungal, antimicrobial and other medicaments and solvents. Additionally, conditioning agents can be used in combination with the polymers of this disclosure, for example, cationic guar gum, cationic hydroxyethyl cellulose, cationic synthetic polymers and cationic fatty amine derivatives. These blended materials help to provide more substantivity and effective conditioning properties in hair.

Some non-limiting examples of polymers that can used in conjunction with the polymers of this disclosure are polyoxythylenated vinyl acetate/crotonic acid copolymers, vinyl acetate crotonic acid (90/10) copolymers, vinyl acetate/crotonic acid/vinyl neodecanoate terpolymers, N-octylacrylamide/methylacrylate/hydroxypropyl methacrylate/acrylic acid/tert-butylaminoethyl methacrylate copolymers, and methyl vinyl ether/maleic anhydride (50/50) copolymers monoesterified with butanol or ethanol, acrylic acid/ethyl acrylate/N-tert-butyl-acrylamide terpolymers, and poly (methacrylic acid/acrylamidomethyl propane sulfonic acid), acrylates copolymer, octylacrylamide/acrylates/butylaminoethyl methacrylate copolymer, acrylates/octylacrylamide copolymer, VA/crotonates/vinyl Neodeanoate copolymer, poly(N-vinyl acetamide), poly(N-vinyl formamide), corn starch modified, sodium polystyrene sulfonate, polyquaterniums such as polyquaternium-4, polyquaternium-7, polyquaternium-10, polyquaternium-11, polyquarternium-16, polyquaternium-28, polyquaternium-29, polyquaternium-46, polyether-1, polyurethanes, VA/acrylates/lauryl methacrylate copolymer, adipic acid/dimethylaminohydroxypropyl diethylene AMP/acrylates copolymer, methacrylol ethyl betaine/acrylates copolymer, PVP/dimethylaminoethylmethacrylate copolymer, PVP/DMAPA acrylates copolymer, PVP/vinylcaprolactam/DMAPA acrylates copolymer, vinyl caprolactam/PVP/dimethylaminoethyl methacrylate copolymer, VA/butyl maleate/isobomyl acrylate copolymer, VA/crotonates copolymer, acrylate/acrylamide copolymer, VA/crotonates/vinyl propionate copolymer, vinylpyrrolidone/vinyl acetate/vinyl propionate terpolymers, VA/crotonates, cationic and amphoteric guar, polyvinylpyrrolidone (PVP), polyvinylpyrrolidone/vinyl acetate copolymer, PVP acrylates copolymer, vinyl acetate/crotonic acid/vinyl proprionate, acrylates/acrylamide, acrylates/octylacrylamide, acrylates/hydroxyacrylates copolymer, and alkyl esters of polyvinylmethylether/maleic anhydride, diglycol/ cyclohexanedimethanol/isophthalates/sulfoisophthalates copolymer, vinyl acetate/butyl maleate and isobornyl acrylate copolymer, vinylcaprolactam/PVP/dimethylaminoethyl methacrylate, vinyl acetate/alkylmaleate half ester/N-substituted acrylamide terpolymers, vinyl caprolactam/vinylpyrrolidone/methacryloamidopropyl trimethylammonium chloride terpolymer methacrylates/acrylates copolymer/amine salt, polyvinylcaprolactam, polyurethanes, hydroxypropyl guar, hydroxypropyl guar hydroxypropyl trimmonium chloride, poly (methacrylic acid/acrylamidomethyl propane sulfonic acid, polyurethane/acrylate copolymers and hydroxypropyl trimmonium chloride guar, particularly acrylates copolymer, octylacrylamide/acrylates/butylaminoethyl methacrylate copolymer, acrylates/octylacrylamide copolymer, VA/crotonates/vinyl Neodeanoate copolymer, poly(N-vinyl acetamide), poly(N-vinyl formamide), polyurethane, corn starch modified, sodium polystyrene sulfonate, polyquaternium-4, polyquarternium-10, and polyurethane/acrylates copolymer.

In addition to the polymers of this disclosure, the personal care compositions of the disclosure may also include a cosmetically acceptable ingredient. The ingredient can be a emollient, fragrance. exfoliant, medicament, whitening agent, acne treatment agent, a preservative, vitamins, proteins, a cleanser or conditioning agent.

Examples of cleansers suitable for use the present disclosure include, but are not limited to, are sodium lauryl sulfate (SLS), sodium laureth sulfate (SLES), ammonium lauryl ether sulfate (ALES), alkanolamides, alkylaryl sulfonates, alkylaryl sulfonic acids, alkylbenzenes, a e acetates, amine oxides, amines, sulfonated amines and amides, betaines, block polymers, carboxylated alcohol or alkylphenol ethoxylates, diphenyl sulfonate derivatives, ethoxylated alcohols, ethoxylated alkylphenols, ethoxylated amines and/or amides, ethoxylated fatty acids, ethoxylated fatty esters and oils, fatty esters (other than glycol, glycerol, etc.), fluorocarbon-based surfactants, glycerol esters, glycol esters, heterocyclics, imidazolines and imidazoline derivatives, isethionates, lanolin-based derivatives, lecithin and lecithin derivatives, lignin and lignin derivatives, methyl esters, monoglycerides and derivatives, olefin sulfonates, phosphate esters, phosphorous organic derivatives, polymeric (polysaccharides, acrylic acid, acrylamide), propoxylated and ethoxylated fatty acids, propoxylated and ethoxylated fatty alcohols, propoxylated and ethoxylated alkyl phenols, protein-based surfactants, quaternary surfactants, sarcosine derivatives, silicone-based surfactants, soaps, sorbitan derivative, sucrose and glucose esters and derivatives, sulfates and sulfonates of oils and fatty acids, sulfates and sulfonates ethoxylated alkyl phenols, sulfates of alcohols, sulfates of ethoxylated alcohols, sulfates of fatty esters, sulfonates of benzene, cumene, toluene and xylene, sulfonates of condensed naphthalenes, sulfonates of dodecyl and tridecyl benzenes, sulfonates of naphthalene and alkyl naphthalene, sulfonates of petroleum, sulfosuccinamates, sulfosuccinates and derivatives.

Preservatives are often used in personal care formulations to provide long term shelf stability. These can be selected from among methylparaben, propylparaben, butylparaben, DMDM hydantoin, imidazolidinyl urea, gluteraldehyde, phenoxyethanol, benzalkonium chloride, methane ammonium chloride, benzethonium chloride, benzyl alcohol, chlorobenzyl alcohol, methylchloroisothiazolinone, methylisothiazolinone, sodium benzoate, chloracetamide, triclosan, iodopropynyl butylcarbamate, sodium pyrithione, and zinc pyrithione.

In an embodiment of this disclosure, particularly where the hair formulation is a shampoo, the formulation contains a sulfate free surfactant and the polymers of this disclosure. Examples of sulfate free surfactants include, but are not limited to, ethoxylated alkylphenols, ethoxylated amines and/or amides, ethoxylated fatty acids, ethoxylated fatty esters and oils, fatty esters (other than glycol, glycerol, etc.), fluorocarbon-based surfactants, glycerol esters, glycol esters, heterocyclics, imidazolines and imidazoline derivatives, isethionates, lanolin-based derivatives, lecithin and lecithin derivatives, lignin and lignin derivatives, methyl esters, monoglycerides and derivatives, phosphate esters, phosphorous organic derivatives, polymeric (polysaccharides, acrylic acid, acrylamide), propoxylated and ethoxylated fatty acids, propoxylated and ethoxylated fatty alcohols, propoxylated and ethoxylated alkyl phenols, protein-based surfactants, quaternary surfactants, sarcosine derivatives, silicone based surfactants, alpha-olefin sulfonate, alkylaryl sulfonates, sulfonates of oils and fatty acids, sulfonates of ethoxylated alkyl phenols, sulfonates of benzene, cumene, toluene and xylene, sulfonates of condensed naphthalenes, sulfonates of dodecyl and tridecyl benzenes, sulfonates of naphthalene and alkyl naphthalene, sulfonates of petroleum and derivatives thereof. In an embodiment of the disclosure, the sulfate free surfactants are sulfonates or ethoxylates.

In another embodiment the formulation contains sulfated surfactants. Some non-limiting examples of sulfated surfactants are sodium lauryl sulfate (SLS), sodium laureth sulfate (SLES), alkanolamides, alkylaryl sulfonic acids, sulfates of oils and fatty acids, sulfates of ethoxylated alkyl phenols, sulfates of alcohols, sulfates of ethoxylated alcohols, sulfates of fatty esters, sulfosuccinamates, sulfosuccinates and derivatives thereof.

In addition to the polymer(s) of this disclosure, shampoo compositions may optionally include other ingredients. Some non-limiting examples of these ingredients include, but are not limited to, conditioning agents such as silicone oils, either volatile or non-volatile, natural and synthetic oils. Suitable silicone oils that can be added to the compositions include dimethicone, dimethiconol, polydimethylsiloxane, silicone oils with various DC fluid ranges from Dow Corning. Suitable natural oils, such as olive oil, almond oil, avocado oil, wheatgerm oil, ricinus oil and the synthetic oils, such as mineral oil, isopropyl myristate, palmitate, stearate and isostearate, oleyl oleate, isocetyl stearate, hexyl laurate, dibutyl adipate, dioctyl adipate, myristyl myristate and oleyl erucate can also be used. Some examples of non-ionic conditioning agents are polyols such as glycerin, glycol and derivatives, polyethyleneglycols, which may be known by the trade names Carbowax® PEG from Union Carbide and Polyox® WSR range from Amerchol, polyglycerin, polyethyleneglycol mono- or di- fatty acid esters.

Suitable cationic polymers that may be used in the formulation are those of best known with their CTFA category name Polyquaternium. Some examples of this class of polymer are Polyquaternium 6, Polyquaternium 7, Polyquaternium 10, Polyquaternium 11, Polyquaternium 16, Polyquaternium 22 and Polyquaternium 28, Polyquaternium 4, Polyquaternium 37, Quaternium-8, Quaternium-14, Quaternium-15, Quaternium-18, Quaternium-22, Quaternium-24, Quaternium-26, Quaternium-27, Quaternium-30, Quaternium-33, Quaternium-53, Quaternium-60, Quaternium-61, Quaternium-72, Quaternium-78, Quaternium-80, Quaternium-81, Quaternium-82, Quaternium-83 and Quaternium-84.

Naturally derived cellulose type polymers known as Polymer JR® type from Amerchol, Polyquaternium 10 or cationic guar gum known with trade name Jaguar® from Rhone-Poulenc, and Guar hydroxypropyl trimonium chloride, chitosan and chitin can also be included in the personal care formulations as cationic natural polymers may also optionally be included with the inventive polymers. Additional gums including xanthan gum, dehydroxanthan gum, carrageenan gum, gellan gum, locust bean gum, acacia gum, tara gum, may also be suitable in formulations containing the inventive polymers. Starch-based rheology modifiers, including hydroxypropyl starch phosphate and potato starch modified may also be employed in these formulations.

Film forming polymers may be included with the inventive polymers at a range of 0.1-10%; cleansing surfactants may be used in a range of 5-30%; cationic polymers may be used in a range of 0.1-5%; cellulose, gums, and starch may be used at a range of 0.1-10%.

The disclosure will now be described in greater detail with reference to the following non-limiting examples.

### EXAMPLES

In the examples the following abbreviations or trade names are employed.
Regular maltodextrins and corn syrups (for comparative examples)
Staley 1300=82.1% DE 42 solution from Tate & Lyle
Star DRI 240=95.2% DE 24 powder from Tate & Lyle
Star DRI 10=91.0% active DE 10 powder from Tate & Lyle
Hydrogenated starch hydrolysates/polyols for examples from this disclosure
Hystar 3375=76.7% active polyol (hydrogenated corn syrup) solution from Ingredion
Hystar 4075=76.7% active polyol (hydrogenated corn syrup) solution from Ingredion
Hystar 6075=77.3% active polyol (hydrogenated corn syrup) solution from Ingredion
Stabilite SD 30=95.4% active polyol (hydrogenated maltodextrin) powder from Ingredion
Polysorb 75/55=75.7% active (hydrogenated corn syrup) polyol solution from Roquette
Polysorb 75/25=75.0% active (hydrogenated corn syrup) polyol solution from Roquette
VenPure™ Solution—˜12% borohydride in 40% sodium hydroxide aqueous solution from Dow

### Comparative Example 1 (DE 42)

An initial charge containing a solution of 262.21 grams of Staley 1300 (corn syrup of DE 42) and 224.92 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.51 grams of maleic anhydride was charged to the reactor. At 187° F., 8.98 grams of 35% hydrogen peroxide solution was charged to the reactor. Immediately after the 35% hydrogen peroxide solution was added, 72.0 grams of acrylic acid was added over 2 hours. A solution of 38.27 grams of 50% solution of sodium hydroxide in 29.17 grams of water was concurrently added over 2 hours. A solution of 9.50 grams of sodium persulfate dissolved in 104.15 grams of water was concurrently added over 2 hours and 30 minutes. At the end of sodium persulfate solution feed, the reactor temperature was maintained at 185-189° F. for an additional one hour. At the end of the hour, the reactor was cooled down to 140° F. 5.6 grams of sodium bisulfite was added to the reactor and the temperature was held at 140° F. for 15 minutes. The reactor was then cooled down to room temperature. Once the temperature had dropped below 113° F., pH of the polymer was adjusted to 8.0 with 37.67 grams of 50% solution of sodium hydroxide. The final polymer solution was dark amber in color and had a solids content of 39.0%.

### Comparative Example 2 (DE 10)

An initial charge containing a solution of 276.5 grams of Star DRI 10 (maltodextrin of DE 10) and 292.5 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.6 grams of maleic anhydride was charged to the reactor. At 187° F., 10.8 grams of 35% hydrogen peroxide solution was charged to the reactor. Immediately after the 35% hydrogen peroxide solution was added, 86.4 grams of acrylic acid was added over 2 hours. A solution of 24.0 grams of 50% solution of sodium hydroxide in 69 grams of water was concurrently added over 2 hours. A solution of 11.4 grams of sodium persulfate dissolved in 125 grams of water was concurrently added over 2 hours and 30 minutes. At the end of sodium persulfate solution feed, the reactor temperature was maintained at 185-189° F. for an additional one hour. The reactor was then cooled down to room temperature. The final polymer solution was yellow in color and had a solids content of 45.8%.

### Comparative Example 3 (DE 24)

An initial charge containing a solution of 225.8 grams of Star DRI 240 (corn syrup of DE 24) and 261.4 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor. Immediately after the 35% hydrogen peroxide solution was added, 72.0 grams of acrylic acid was added over 2 hours. A solution of 38.27 grams of 50% solution of sodium hydroxide in 29.17 grams of water was concurrently added over 2 hours. A solution of 9.5 grams of sodium persulfate dissolved in 104.15 grams of water was concurrently added over 2 hours and 30 minutes. At the end of sodium persulfate solution feed, the reactor temperature was maintained at 185-189° F. for an additional one hour. At the end of the hour, the reactor was cooled down to 140° F. 5.6 grams of sodium bisulfite was added to the reactor and the temperature was held at 140° F. for 15 minutes. The reactor was then cooled down to room temperature. Once the temperature had dropped below 113° F., pH of the polymer was adjusted to 8.0 with 37.67 grams of 50% solution of sodium hydroxide. The final polymer solution was dark amber in color and had a solids content of 40.4%.

### Comparative Example 4 (DE 10)

To a glass reactor was added 660.3 g 94% StarDri 100 (DE 10 maltodextrin from Tate and Lyle) and 1128.1 g water. The contents were heated to 60° C. with constant stirring. 31.1 g 35% hydrogen peroxide were added to the reactor contents, which were then heated to 87° C. A solution of 321.3 g acrylic acid and 26.2 g vinyl acetate was slowly added to the reactor contents over a period of 2.5 hours. A separate slow addition of initiator solution containing 84.7 g sodium persulfate, 482 g water, and 28.5 g 35% hydrogen peroxide was simultaneously added to the reactor contents over the same time period. A third slow addition of a caustic solution containing 311.8 g 50% sodium hydroxide and 86.6 g water was also added to the reactor contents over the same time period. After all three feeds had finished, the reactor contents were cooked an additional 30 minutes, resulting in a light yellow, homogeneous polymer solution.

### Comparative Example 5 (75/25 DE 42/AA)

To a glass reactor was added 377.6 g 81% Staley 1300 (available from Tate and Lyle) and 249.1 g of water. The contents were heated to 60° C. with constant stirring. 13.0 g 35% hydrogen peroxide, 0.01 g maleic anhydride, and 0.01 g itaconic acid were added to the reactor. The contents were cooked for 10 minutes then the temperature was raised to 87° C. A monomer solution of 103.8 g acrylic acid and 41.5 g water was added to the reactor contents over a period of 120 minutes. A concurrent feed of 13.7 g sodium persulfate dissolved in 149.4 g water was fed over the 135 minutes. Upon completion of the feeds, the contents were cooked an additional 1 hour before being cooled to ambient and 51.9 g 50% NaOH was added. The result was a clear, homogeneous polymer solution.

### Comparative Example 6 (DE-42 75/25)

To a glass reactor was added 218.3 g 81% Staley 1300 (available from Cargill), 144 g of water, 7.5 g 35% hydrogen peroxide, 0.01 g maleic anhydride, and 0.01 g itaconic acid. The contents were heated to 87° C. A monomer solution of 60 g acrylic acid and 24 g water was added to the reactor contents over a period of 120 minutes. A concurrent feed of 7.9 g sodium persulfate dissolved in 86.4 g water was fed over the 135 minutes. Upon completion of the feeds, the contents were cooked an additional 1 hour before being cooled to ambient and 30 g 50% NaOH was added. The result was a clear, homogeneous polymer solution.

### Comparative Example 7 (DE-42 75/15/10)

To a glass reactor was added 94.6 g of 94.4% DE 42 maltodextrin (Star Dri 42 from Tate and Lyle) and 103.6 g water. The contents were heated to 87° C. with constant stirring. To this mixture 4.5 g of 35% hydrogen peroxide was added. To this mixture was added 11.9 g maleic anhydride and 0.0050 g ferrous ammonium sulfate hexahydrate. After dissolution, the contents were partially neutralized with 9.8 g 50% NaOH. 17.8 g acrylic acid in 15 g water was added to the reactor contents over a period of 3 hours. A concurrent feed of 1.9 g sodium persulfate dissolved in 10 g water and 14.2 g 35% hydrogen peroxide was fed over 3.25 hours. Upon completion of the feeds, the contents were cooked an additional 1 hour before being cooled to 50° C. The contents were further neutralized with 12.4 g of 50% NaOH The result was a clear, homogeneous polymer solution.

### Comparative Example 8

Polymer 4 from EP0725131A1 was repeated. This uses Polyol 300 from Cerestar but this material is no longer commercially available. We replaced this material with SD 30 which is used in our Example 9 and which has<0.1 mol % aldehyde end groups based on total moles of saccharide units.

### Comparative Example 9

Polymer 3 from EP0725131A1 was repeated but using Cargill 01915 instead of Cerestar PUR 01915. (We believe Cargill bought Cerestar and renamed the product.)

### Example 1 (Polysorb 75/55)

The polymerization of comparative Example 1 was repeated except that the Staley 1300 (corn syrup of DE 42) was replaced by an equal solids amount of Polysorb 75/55 (hydrogenated corn syrup). The final polymer solution was light yellow in color and had a solids content of 40.5%. In comparison, the final polymer solution of comparative Example 1 was dark amber in color.

Surprisingly, we have found that there is slight yellowing in the ageing test even when the polyols were used in Example 1 (see Example 5). It appears that there is depolymerization of the polyols leading to additional aldehyde end group generation especially when the persulfate initiator is added past the monomer and acrylic acid feed.

In Examples 2, 3 and 4 the sodium persulfate feed time was shortened to minimize depolymerization of the polyols during the polymerization process and the improved color by making this change is exemplified in Example 5, while ensuring that the monomer is polymerized as detailed by the low residual acrylic acid numbers.

### Example 2 (Polysorb 75/22, Shorter Persulfate Feed than Example 1)

An initial charge containing a solution of 293.3 grams of Polysorb 75/22 and 177.6 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 20 grams of 50% solution of sodium hydroxide in 57.5 grams of water was concurrently added over 2 hours. A solution of 7.3 grams of sodium persulfate dissolved in 104.15 grams of water was concurrently added over 1 hours and 55 minutes. At the end of feeds, the reactor temperature was maintained at 185-189° F. for an additional one hour. The reactor was then cooled down to room temperature. The final polymer solution was light yellow in color and had a solids content of 40.6%.

### Example 3 (Polysorb 75/22, Shorter Persulfate Feed than Example 1 and 2)

An initial charge containing a solution of 293.3 grams of Polysorb 75/22 and 177.6 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 20 grams of 50% solution of sodium hydroxide in 57.5 grams of water was concurrently added over 2 hours. One minute into the feed, a solution of 4.75 grams of sodium persulfate and 104.14 grams of water was added over 1 hour 30 minutes. At the end of feeds, the reactor temperature was maintained at 185-189° F. for an additional one hour. The reactor was then cooled down to room temperature. The final polymer solution was a light yellow in color and had a solids content of 40.5%.

### Example 4 (Polysorb 75/22, Shorter Persulfate Feed than Example 1, 2 and 3)

An initial charge containing a solution of 293.3 grams of Polysorb 75/22 and 177.6 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 20 grams of 50% solution of sodium hydroxide in 57.5 grams of water was concurrently added over 2 hours. One minute into the feed, a solution of 4.75 grams of sodium persulfate and 104.14 grams of water was added over 1 hour 15 minutes. At the end of feeds, the reactor temperature was maintained at 185-189° F. for an additional one hour. The reactor was then cooled down to room temperature. The final polymer solution was light yellow in color and had a solids content of 40.3%.

### Example 5—Comparison of the Yellowing of 1-4 with Comparative Example

1% active polymer solutions of Comparative Example 1 and Examples 1, 2, 3 and 4 were prepared in pH 9.2 buffer solutions since discolorization is especially noticeable under alkaline conditions. The buffer solution was prepared by dissolving 7.65 g of sodium bicarbonate and 0.96 grams of sodium carbonate in a 1 L deinoized water.

These 1% polymer solutions were aged at 178° F. (80° C.) for 6 hours. These polymer solutions were then cooled down to room temperature and colorimetric analysis was completed by measuring absorbance at 520 nm using a Hach DR5000. The higher the absorbance number the darker the sample or the greater the discolorization.

| | Absorption | % Residual acrylic acid |
|---|---|---|
| | (ABS) | in the polymer solution |
| Comparative Example 1 | 0.135 | <0.1 |
| Polysorb 75/22 (polyol) | 0.0 | NA |
| Example 1 | 0.060 | <0.1 |
| Example 2 | 0.013 | <0.1 |
| Example 3 | 0.011 | <0.1 |
| Example 4 | 0.007 | <0.1 |

Comparative Example 1 and Example 1 is the same recipe except that a hydrogenated corn syrup Polysorb 75/22 is used in Example 1 while a regular corn syrup is used in Comparative Example 1. The absorbance numbers indicate that the color of the solution produced by using Example 1 is significantly lower than the color of the solution produced by using Comparative Example 1. This difference can be visually seen: the color of the solution produced by using Example 1 is light yellow whereas the color of the solution produced by using Comparative Example 1 is amber. The color of the Polysorb 75/22 in this test is water white indicating that it has no reducing end groups. Therefore, the color of the polymer of Example 1 being yellow by comparison indicates that there is a certain amount of depolymerization of the polyol during the polymerization of acrylic acid. This can be minimized by lowering the amount of persulfate in Example 1 as exemplified in Examples 2, 3 and 4 the color is further lowered proportional to the decrease in persulfate as shown in the table above. The lowering of the persulfate and shortening the time it is added compared to the acrylic acid monomer leads to minimizing the depolymerization of the polyols which generates additional aldehyde end groups generation especially when the persulfate initiator is added past the monomer and acrylic acid feed. The color of the solution of Example 4 is approximately one order of magnitude lower than the color of the solution of Example 1 and approximately two orders of magnitude lower than the color of the solution of Comparative Example 1. In Examples 1-4, the reaction temperature is 185F and the acrylic acid is added over 2 hours. The half-life of the sodium persulfate initiator at 185F is approximately 1 hour. Therefore, the sodium persulfate feed can possible be shortened to 1 hour even though the acrylic acid is added over 2 hours. These examples indicate that the initiator feed can be controlled to minimize depolymerization of the polyol while ensuring that the monomers are polymerized as indicated by the less than 0.1 mol % residual acrylic acid in these samples. One skilled in the art will recognize that if there is high amount of residual monomer which is typically greater than 0.1-0.5 weight % of the polymer solution typically containing 30-50 weight % polymer, it indicates that the initiator feed is too short and may need to be lengthened.

### Example 6

An initial charge containing a solution of 293.3 grams of Hystar 3375 and 177.6 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 20 grams of 50% solution of sodium hydroxide in 57.5 grams of water was concurrently added over 2 hours. One minute into the feed, a solution of 7.3 grams of sodium persulfate dissolved in 104.15 grams of water was concurrently added over 1 hours and 55 minutes. At the end of feeds, the reactor temperature was maintained at 185-189° F. for an additional one hour. The reactor was then cooled down to room temperature. The final polymer solution was light yellow in color and had a solids content of 40.7%.

### Example 7

An initial charge containing a solution of 1492 grams of Hystar 4075 (hydrogenated corn syrup) and 957 grams of water was added to a 5 liter 5 necked round bottom flask fitted with a condenser, heating mantle, temperature probe and controller and overhead stirring. The contents of the reactor were started to be heated to 187° F. When the temperature of the initial charge reached 140° F., 2.6 grams of maleic anhydride was charged to the reactor. At 187° F., 46.7 grams of 35% hydrogen peroxide solution was charged to the reactor. Immediately after the 35% hydrogen peroxide solution was added, 374.4 grams of acrylic acid was added over 2 hours. A solution of 103.9 grams of 50% solution of sodium hydroxide in 299 grams of water was concurrently added over 2 hours. One minute into the feed, a solution of 37.9 grams of sodium persulfate dissolved in 542 grams of water was concurrently added over 1 hours and 55 minutes. At the end of feeds, the reactor temperature was maintained at 185-189° F. for an additional one hour. The reactor was then cooled down to room temperature. The final polymer solution was light yellow in color and had a solids content of 40.3%.

### Example 8

An initial charge containing a solution of 307.3 grams of Hystar 6075 (hydrogenated corn syrup) and 201.3 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.54 grams of maleic anhydride was charged to the reactor. At 187° F., 9.7 grams of 35% hydrogen peroxide solution was charged to the reactor. Immediately after the 35% hydrogen peroxide solution was added, 77.8 grams of acrylic acid was added over 2 hours. A solution of 21.6 grams of 50% solution of sodium hydroxide in 62 grams of water was concurrently added over 2 hours. One minute into the feed, a solution of 7.9 grams of sodium persulfate dissolved in 112.5 grams of water was concurrently added over 1 hours and 55 minutes. At the end of feeds, the reactor temperature was maintained at 185-189° F. for an additional one hour. The reactor was then cooled down to room temperature. The final polymer solution was light yellow in color and had a solids content of 39.8%.

### Example 9

An initial charge containing a solution of 1432.5 grams of Stabilite SD 30 (hydrogenated maltodextrin) and 1638 grams of water was added to a 5 liter 5 necked round bottom flask fitted with a condenser, heating mantle, temperature probe and controller and overhead stirring. The contents of the reactor were started to be heated to 187° F. When the temperature of the initial charge reached 140° F., 3.3 grams of maleic anhydride was charged to the reactor. At 187° F., 58.5 grams of 35% hydrogen peroxide solution was charged to the reactor. Immediately after the 35% hydrogen peroxide solution was added, 469.5 grams of acrylic acid was added over 2 hours. A solution of 103.9 grams of 50% solution of sodium hydroxide in 375 grams of water was concurrently added over 2 hours. One minute into the feed, a solution of 47.5 grams of sodium persulfate dissolved in 679 grams of water was concurrently added over 1 hours and 55 minutes. At the end of feeds, the reactor temperature was maintained at 185-189° F. for an additional one hour. The reactor was then cooled down to room temperature. The final polymer solution was light yellow in color and had a solids content of 40.8%.

### Example 10—Borohydride Post-Treatment

300 grams of the polymer solution of Comparative Example 1 was added to a 500 ml 5 neck round bottom flask with condenser. The reactor was then heated to 113° F. and 23.95 grams of VenPure™ Solution (borohydride) was added subsurface under high agitation over 30 minutes. The temperature was maintained below 120° F. during the borohydride addition. At the end of borohydride addition, reactor temperature maintained at 113° F. for 2 hours and 30 minutes. The reaction mixture was then cooled down to room temperature and the pH was 12.8. The pH was adjusted to 7.2 using 26.1 grams of 10.0 N sulfuric acid. The final solution was light yellow in color and had a solids content of 35.4%.

### Example 11—Borohydride Post-Treatment

300 grams of the polymer solution of Comparative Example 1 was added to a 500 ml 5 neck round bottom flask with condenser. The reactor was then heated to 113° F. and 10.2 grams of VenPure™ Solution (borohydride) was added subsurface under high agitation over 30 minutes. The temperature was maintained below 120° F. during the borohydride addition. At the end of borohydride addition, reactor temperature maintained at 113° F. for 2 hours and 30 minutes. The reaction mixture was then cooled down to room temperature and the pH was 12.5. The pH was adjusted to 7.2 using 13.9 grams of 10.0 N sulfuric acid. The final solution was light brown in color and had a solids content of 37.6%.

### Example 12—Borohydride Post-Treatment

300 grams of the polymer solution of Comparative Example 3 was added to a 500 ml 5 neck round bottom flask with condenser. The reactor was then heated to 113° F. and 16.2 grams of VenPure TM Solution (borohydride) was added subsurface under high agitation over 30 minutes. The temperature was maintained below 120° F. during the borohydride addition. At the end of borohydride addition, reactor temperature maintained at 113° F. for 2 hours and 30 minutes. The reaction mixture was then cooled down to room temperature and the pH was 12.9. The pH was adjusted to 7.2 using 26 grams of 10.0 N sulfuric acid. The final solution was light yellow in color and had a solids content of 35.6%.

### Example 13 a-h—Post Treatment with Ca and Mg Salts Such as Chlorides and Hydroxides

An initial charge containing a solution of 1870.15 grams of Hystar 3375 and 1200.15 grams of water was added to a 5 liter 5 necked round bottom flask fitted with a condenser, heating mantle, temperature probe and controller and overhead stirring. The contents of the reactor were started to be heated to 187° F. When the temperature of the initial charge reached 140° F., 3.2 grams of maleic anhydride was charged to the reactor. At 187° F., 58.5 grams of 35% hydrogen peroxide solution was charged to the reactor Immediately after the 35% hydrogen peroxide solution was added, 469.5 grams of acrylic acid was added over 2 hours. A solution of 130.29 grams 50% solution of sodium hydroxide and 374.92 grams of water was concurrently added over 2 hours. One minute into the feed, a solution of 47.5 grams of sodium persulfate dissolved in 679 grams of water was concurrently added over 1 hours and 55 minutes. At the end of feeds, the reactor temperature was maintained at 185-189° F. for an additional one hour. The reactor was then cooled down to room temperature.

The polymer solution was then divided into smaller batches and post addition was completed as below:

| | | | | grams of | grams of |
|---|---|---|---|---|---|
| | | grams of | | Calcium | Magnesium |
| | grams of | Calcium | grams of | chloride, | chloride |
| Exam- | Example | hydroxide, | Magnesium | 50% | hexahydrate, |
| ple | 13 | 5% slurry | hydroxide | solution | 50% solution |
| 13a | 320 | 79.87 | | | |
| 13b | 327.11 | 163.29 | | | |
| 13c | 349.29 | | 6.86 | | |
| 13d | 345.29 | | 8.82 | | |
| 13e | 320.76 | | | 15.85 | |
| 13f | 298.18 | | | 32.40 | |
| 13g | 338.87 | | | | 29.45 |
| 13h | 338.87 | | | | 47.84 |
| 13i | 340.88 | | | | 61.48 |

### Example 14 a-h—Post Treatment with CaCl₂, MgCl₂, Ca(OH)₂ and Mg(OH)₂)

An initial charge containing a solution of 1870.15 grams of Hystar 3375 and 1200.15 grams of water was added to a 5 liter 5 necked round bottom flask fitted with a condenser, heating mantle, temperature probe and controller and overhead stirring. The contents of the reactor were started to be heated to 187° F. When the temperature of the initial charge reached 140° F., 3.2 grams of maleic anhydride was charged to the reactor. At 187° F., 58.5 grams of 35% hydrogen peroxide solution was charged to the reactor Immediately after the 35% hydrogen peroxide solution was added, 469.5 grams of acrylic acid was added over 2 hours. A solution of 130.29 grams 50% solution of sodium hydroxide and 374.92 grams of water was concurrently added over 2 hours. One minute into the feed, a solution of 30.97 grams of sodium persulfate dissolved in 679 grams of water was concurrently added over 1 hours and 15 minutes. At the end of feeds, the reactor temperature was maintained at 185-189° F. for an additional one hour. The reactor was then cooled down to room temperature. The polymer solution was then divided into smaller batches and post addition was completed as below:

| | | | | grams of | grams of |
|---|---|---|---|---|---|
| | | grams of | | Calcium | Magnesium |
| | Grams of | Calcium | grams of | chloride, | chloride |
| Exam- | Example | hydroxide, | Magnesium | 50% | hexahydrate, |
| ple | 14 | 5% slurry | hydroxide | solution | 50% solution |
| 14a | 347.59 | 86.76 | | | |
| 14b | 319 | 159.24 | | | |
| 14c | 340.9 | | 6.70 | | |
| 14d | 323.23 | | 8.26 | | |
| 14e | 322.83 | | | 17.214 | |
| 14f | 332.11 | | | 31.596 | |
| 14g | 327.37 | | | | 46.69 |
| 14h | 328.48 | | | | 57.56 |
| 14i | 329.48 | | | | 28.45 |

### Example 15 (No Peroxide and Maleic Anhydride)

An initial charge containing a solution of 293.35 grams of Polysorb 75/22 and 177.56 grams of water was added to a 2 liter 5 necked round bottom flask fitted with a condenser, heating mantle, temperature probe and controller and overhead stirring. The contents of the reactor was heated to 187° F. and 72 grams of acrylic acid was added over 2 hours. A solution of 20 20 grams of 50% solution of sodium hydroxide in 57.5 grams of water was concurrently added over 2 hours. One minute into the feed, a solution of 4.8 grams of sodium persulfate dissolved in 104 grams of water was concurrently added over 1 hours and 15 minutes. At the end of feeds, the reactor temperature was maintained at 185-189° F. for an additional one hour. At the end of the hour, the reactor was cooled down to 140° F. The reactor was then cooled down to room temperature. The final polymer solution was dark yellow in color and had a solids content of 40.6%.

### Example 16 (Peroxide in Feed, No Maleic Anhydride)

An initial charge solution of 293.34 grams of Polysorb 75/22 and 177.57 grams of water was added to a 2 liter 5 neck round bottom flask with condenser. The reactor content was heated to 187° F. Once the temperature was stable at 187° F., 72.0 grams of AA was added over 2 hours. A solution of 19.97 grams 50% solution of sodium hydroxide and 57.51 grams of water was added over 2 hours simultaneously. One minute into the feed, a solution of 4.75 grams of Sodium persulfate, 8.98 grams of 35% hydrogen peroxide solution and 104.16 grams of water was added over 75 minutes. At the end of monomer and 50% solution of sodium hydroxide solution feed, the reactor temperature was maintained at 185-189° F. for an additional one hour. The polymer solution was cooled down at the end of the cook and collected. The final polymer solution was light yellow in color and had a solids content of 40.5%.

### Example 17 (Peroxide in Feed, Maleic Anhydride in Feed)

An initial charge containing a solution of 293.33 grams of Polysorb 75/22 and 177.56 grams of water was added to a 2 liter 5 necked round bottom flask fitted with a condenser, heating mantle, temperature probe and controller and overhead stirring. The contents of the reactor were started to be heated to 187° F. 77.8 grams of acrylic acid and 0.50 grams of maleic anhydride was added over 2 hours. A solution of 19.98 grams 50% solution of sodium hydroxide and 57.5 grams of water was concurrently added over 2 hours. One minute into the feed, a solution of 4.8 grams of sodium persulfate, 8.99 grams of 35% hydrogen peroxide solution and 104.18 grams of water was concurrently added over 1 hours and 15 minutes. At the end of feeds, the reactor temperature was maintained at 185-189° F. for an additional one hour. The reactor was then cooled down to room temperature. The final polymer solution was light yellow in color and had a solids content of 40.8%.

### Example 18

An initial charge containing a solution of 293.3 grams of Hystar 3375 and 177.6 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 20 grams of 50% solution of sodium hydroxide in 57.5 grams of water was concurrently added over 2 hours. One minute into the feed, a solution of 4.7 grams of sodium persulfate dissolved in 104.15 grams of water was concurrently added over 1 hours and 15 minutes. At the end of feeds, the reactor temperature was maintained at 185-189° F. for an additional one hour. The reactor was then cooled down to room temperature. The final polymer solution was light yellow in color and had a solids content of 40.5%.

### Example 19—Post Treatment with Borohydride

300 grams of the polymer solution of Comparative Example 3 was added to a 500 ml 5 neck round bottom flask with condenser. The reactor was then heated to 113° F. and 32.4 grams of VenPure TM Solution (12% borohydride solution in caustic) was added subsurface under high agitation over 30 minutes. The temperature was maintained below 120° F. during the borohydride addition. At the end of borohydride addition, reactor temperature maintained at 113° F. for 2 hours and 30 minutes. The reactor was then cooled down to room temperature and pH was adjusted to 7.2 using 42.4 grams of 10.0 N sulfuric acid. The final solution was light yellow in color and had a solids content of 33.4%.

### Example 20 (Yellowness Screening Test Result, NMR Data)

1% active polymer solutions were prepared in a pH 9.2 buffer solution using the Comparative Examples and the Examples of this disclosure since discolorization is especially noticeable under alkaline conditions. The buffer solution was prepared by dissolving 7.65 g of sodium bicarbonate and 0.96 grams of sodium carbonate in a 1L deionized water.

These 1% polymer solutions were then stored at 178° F. (80° C.) for 6 hours. These polymer solutions were then cooled down to room temperature and colorimetric analyses were performed by measuring absorbance at 520 nm using Hach DR5000. The higher the absorbance number the darker the sample or the greater the discolorization.

| | Absorption |
|---|---|
| Comparative Example 1 | 0.135 |
| Comparative Example 2 | 0.100 |
| Comparative Example 3 | 0.514 |
| Comparative Example 8 | 0.334 |
| Comparative Example 9 | 0.441 |
| Example 1 | 0.060 |
| Example 2 | 0.013 |
| Example 3 | 0.011 |
| Example 4 | 0.007 |
| Example 6 | 0.009 |
| Example 7 | 0.042 |
| Example 8 | 0.013 |
| Example 9 | 0.009 |
| Example 10 | 0.198 |
| Example 11 | 0.382 |
| Example 12 | 0.032 |
| Example 15 | 0.027 |
| Example 16 | 0.010 |
| Example 17 | 0.008 |
| Example 14a | 0.033 |
| Example 14b | 0.077 |
| Example 14c | 0.050 |
| Example 14d | 0.044 |
| Example 14e | 0.010 |
| Example 14f | 0.030 |
| Example 14g | 0.014 |
| Example 14h | 0.009 |
| Example 14i | 0.007 |

Comparative Example 2 and Example 9 are similar polymers except that a hydrogenated maltodextrin is used in Example 9 while a regular maltodextrin is used in Comparative Example 2. The absorbance numbers indicate that the color of the solution produced by using Example 9 (0.009) is significantly lower than the color of the solution produced by using Comparative Example 2 (0.100).

The effect of decreasing color by minimizing the aldehyde end groups using different levels of borohydride post treatment is exemplified by comparing Example 10 (0.198) and 11 to comparative Example 1 when corn syrups are used.

The effect of decreasing color by minimizing the aldehyde end groups using borohydride post treatment is exemplified by comparing Example 12 where is absorbance is 0.032 is significantly lower than the 0.514 absorbance of comparative Example 2 when maltodextrins are used.

The calcium and magnesium salts appear to surprisingly lower the color to less discolorization and almost water white solutions (14e, h and i) as exemplified in the table above for Examples 14a-i.

The ¹H NMR spectra were acquired on a Varian 400 MHz NMR spectrometer using a 90° pulse, water suppression with a 2 s saturation delay, a 10 s relaxation delay and 16 scans. The spectra were acquired at 90° C. and the water peak was referenced to 4.11 ppm. Spectra were then analyzed to determine the aldehyde end group or reactive end group (REG) for the polymers.

The integrals in each spectrum are normalized to the integral of the peak corresponding to the alpha 1,4 linkages at 5.17 ppm, set to 100.

The peaks corresponding to the protons bonded to closed end groups in beta and alpha forms occur at 4.46 ppm and 5.05 ppm, respectively. The sum of these two integrals represents the total (relative) number of potential REGs.

If the polysaccharide has been treated with sodium borohydride or is a polyol/hydrogenated starch hydrolysates (HSHs), the peak corresponding to the proton of penultimate glucose unit's 1,4 linkage occurs at 4.95 ppm. The proton of the terminal unit is not observable in the ¹H NMR spectrum, so the integral for the peak at 4.95 ppm needs to be multiplied by 2 in end group calculations.

The peak corresponding to protons bonded to alpha 1,6 linkages, or branch points on the polysaccharide occurs at 4.78 ppm.

For regular polysaccharides and their hybrids, the mole percent of aldehyde end groups based on total moles of saccharide units was calculated using the integrations of the peaks indicated in the formula below:

(4.46 ppm+5.05 ppm)/(4.46 ppm+5.05 ppm+5.17 ppm+4.78 ppm)*100

For hydrogenated starch hydrosylates/polyols and their hybrids, the mole percent of aldehyde end groups based on total moles of saccharide units was calculated using the integrations of the peaks indicated in the formula below:

(4.46 ppm+5.05 ppm)/(4.46 ppm+5.05 ppm+5.17 ppm+4.78 ppm+2*4.95 ppm)*100

The mole percent of the aldehyde end groups based on total moles of saccharide units for each sample are shown in the table below.

| | Mole % aldehyde end groups based on |
|---|---|
| | total moles of saccharide units (mole %) |
| Comparative Example 1 | 38.5 |
| Comparative Example 3 | 23.3 |
| Comparative Example 8 | 28.6 |
| Comparative Example 9 | 15.0 |
| Polysorb 75/22 | Aldehyde end groups not detected |
| Example 3 | 1.4 |
| Example 4 | 1.0 |
| Example 10 | 0.6 |
| Example 12 | 1.0 |
| Example 18 | 0.6 |
| Example 19 | 1.3 |

These data indicate that the mole % aldehyde end groups based on total moles of saccharide units for Comparative Examples 1 and 3 are much higher than the Examples of this present disclosure and as shown in the decolorization testing above this leads to lower discolorization or browning.

Comparative Examples 8 and 9 from prior art EP0725131A1 have 28.6 and 15.0 mole % aldehyde end groups based on total moles of saccharide units respectively, showing that phosphorus incorporation in the polymer does not help minimize the aldehyde end groups and therefore does not minimize discolorization. Furthermore, the polyol used in Comparative Example 8 is the same as that used in Example 9. Example 9 has 1.9 mole % aldehyde end groups based on total moles of saccharide units compared with 28.6% for Comparative Example 8. In addition the color as measured by absorbance (higher numbers more discolorization) for Examples 9 is 0.009 compared with 0.334 for Comparative Example 8. This is because the depolymerization of the polyol is minimized in Example 9 and it was not in Comparative Example 8.

### Example 21

The polymer solutions of comparative Example 1 and Example 3 were spray dried. 20 g of these spray dried powders were then put in a humidity chamber at 45° C. and 85% relative humidity for 24 hours. The spray dried powder of Example 3 was white in color after ageing in the humidity chamber and had a moisture pickup of 12.1%. In comparison, the spray dried powder of comparative Example 1 after ageing in the humidity chamber was yellow in color and had a moisture pickup of 13.6%. On a subjective color scale where 0 is no yellowing to 4 being very yellow, the spray dried powder of Example 3 was 0.5 after ageing in the humidity chamber. In comparison, the spray dried powder of comparative Example 1 after ageing in the humidity chamber was rated a 4 in yellowness color. These data indicate that the polymers of this present disclosure discolor less and are less hygroscopic and the polymers of the prior art.

### Example 22—Rheology Modifier Synthesis

An initial charge containing a solution of 565.1 grams of water and 57.2 grams of Stabilite SD 30 was charged to a 2 liter kettle reactor fitted with a 5-neck kettle top, a condenser, heating mantle, temperature probe and controller and overhead stirring. The initial charge was heated to 178° F. and sparged with nitrogen. The reactor was held at 178° F. for an hour. A monomer mixture of 99.1 grams of ethyl acrylate, 41.0 grams of methacrylic acid and 11.2 grams of a mixture of 50% C₁₆₋₁₈ alcohol with 20 moles ethoxylate methacrylate (associative monomer), 25% methacrylic acid and 25% water was added over 1 hour 30 minutes with subsurface feed. A solution of 0.54 grams of ammonium persulfate in 61.4 grams of water was concurrently added over 1 hour 30 minutes. At the end of the feed, temperature was held at 178° F. for 2 hours. The reactor was then cooled down to room temperature and reaction product was filtered through 210-micron filter. The final product was white emulsion with 23.5% solids at a pH of 2.5.

### Example 23—Rheology Modifier Synthesis

An initial charge containing a solution of 608.0 grams of water and 161.1 grams of Polysorb 75/22 was charged to a 2 liter kettle reactor fitted with a 5-neck kettle top, a condenser, heating mantle, temperature probe and controller and overhead stirring. The initial charge was heated to 178° F. and sub surface sparged with nitrogen. The reactor was held at 178° F. for an hour. A monomer mixture of 28.0 grams of ethyl acrylate, 12.3 grams of methacrylic acid and 0.18 grams of trimethylolpropane triacrylate was added over 1 hour 30 minutes with subsurface feed. A solution of 0.15 grams of ammonium persulfate in 50.2 grams of water was concurrently added over 1 hour 30 minutes. At the end of the feed, temperature was held at 178° F. for 2 hours. The reactor was then cooled down to room temperature and reaction product was filtered through 210-micron filter. The final product was white emulsion with 19.5% solids at a pH of 2.4.

### Example 24: Hydrogenation After Hybrid Copolymerization

880 g of a polymer product of comparative example 4 is taken in 22 g of a 50% solution of the activated nickel in water is added and is stirred for about 30 minutes at room temperature. The mixture is transferred to a 2 liter Parr reactor. The reactor is sealed and stirred at 500 rpm. The reactor is pressurized to 1100 psi with hydrogen gas and heated to 115° C. to initiate hydrogenation of the maltodextrin portion of the hybrid polymer. The reaction is stopped after 5 hours by cooling and the reactor is depressurized. The reaction mixture is filtered to remove the nickel catalyst and to give a clear polymer solution.

### Enzyme Degradation Examples

### Example 25—Preparation of (Alpha) Limit Dextrin from Waxy Maize Starch

To a 4 L plastic beaker was charged 3094 g water and 794.6 g waxy maize starch (AMIOCA, available from Ingredion; 88.1% solids). The resulting slurry was stirred at about 22-25° C. with a paddle mixer for 30 minutes to ensure uniform distribution of the starch granules in water.

The slurry was then jet-cooked with steam using a laboratory-scale steam jet cooker (custom-built). The flow rate of the slurry to the cooker was 128 mL/minute; the steam mass flow was 8-9 lbs./h; and the cooking temperature was 109-112° C. The yield of the hazy, viscous starch dispersion in water was 4246 g. Dispersion solids (measured gravimetrically at 130° C. oven; duplicate measurements): 14.7%; this corresponds to a 624 g (89%) yield of cooked waxy maize (dry basis). pH of the dispersion: 8.45@18° C. The dispersion was stored overnight at 2-8° C. (no preservative added).

To a 5 L jacketed beaker was charged 4094 g of the waxy maize starch dispersion in water (602 g starch, dry basis). The dispersion was then heated to 50±1° C. while stirring with an overhead mechanical stirrer. When the temperature reached 50° C., the stirring rate was set to 500 rpm and the pH was adjusted to 5.5 by dropwise addition of about 2 g of dilute (5.2 wt. %) sulfuric acid.

In parallel, a dispersion of 1.05 g alpha-amylase (from Bacillus species; obtained from Sigma; 330 KNU/g) in 23.93 g water was prepared.

To the waxy maize dispersion was then added 16.15 g of the dispersion of a-amylase in water (224 KNU). As the viscosity of the waxy maize dispersion decreased, the stirring rate was adjusted to 350 rpm. The enzyme catalyzed hydrolysis was allowed to continue at 50° C. for a total of 5 h. The reaction mixture (less about 60 g) was then freeze-dried (FTS Systems Inc. Dura-Top™ P Microprocessor Control Bulk Tray Dryer/Dura-Dry Microprocessor Control Corrosion Resistant Freeze-Dryer). The yield of solid product thus obtained was 672 g. Solids (measured gravimetrically at 130° C. oven; duplicate measurements): 91.2%.

### Example 26—Preparation of (Alpha) Limit Dextrin from Waxy Maize Starch

An additional quantity of (alpha) limit dextrin from waxy maize starch was prepared using the procedure described in Example 2321-67.

The yield of solid material obtained was 1269 g. Solids (measured gravimetrically at 130° C. oven; duplicate measurements): 94.2%.

### Example 27

100 grams of active DE 10 maltodextrin (Star Dri 10 from Tate and Lyle) was dissolved in 100 g of potassium phosphate buffer at pH 6.3 in a glass reactor with constant stirring. 0.0475 g of calcium chloride dihydrate and 0.0475 g of Validase HT 425 L (from Valley Research) were added to the reactor and the contents were heated to 95° C. with constant stirring for one hour and twenty minutes. The final solution had 45% solids.

### Example 28: Molecular Weight Information for Enzyme Degraded Starches

The degree of polymerization distributions were determined by analysis by GPC/ELSD/MS on a TSK Oligo PW column

About 20.0 mg of sample was weighed out and dissolved in 1.0 ml of mobile phase. Variable injection volumes were made to get about the same amount of material in each chromatogram.
Solvent: 25 mm Ammonium Formate pH 3.0 80% water/20% Acetonitrile
Flow Rate: 0.75 ml/min
Detection: Softa ELSD and Waters LCT

Calibration was done using LC/MS, noting retention times for degree of polymerization/DP 1 to DP 25, and then an offset to the times was made using the retention times measured by GPC/RI for the DP 2 and DP3 peaks.

It can be seen from the molecular weight/degree of polymerization distributions obtained that the enzyme degraded starches of Examples 25, 26 and 27 have low monosaccharide (DP 1)/disaccharide (DP 2) content and high oligomeric content DP's 4, 5, and 6.

| | | | | StarDri 42R | StarDri 10 |
|---|---|---|---|---|---|
| | Example | Example | Example | (comparative | (comparative |
| | 25 | 26 | 27 | DE 42) | DE 10) |
| | Area % | Area % | Area % | Area % | Area % |
| DP1 | 1.22 | 1.3 | 3 | 16.4 | 0.5 |
| DP2 | 11.06 | 11.26 | 10 | 14.1 | 1.4 |
| DP 1 + | 12.28 | 12.56 | 13 | 30.5 | 1.9 |
| DP 2 | | | | | |
| DP 4 + | 39.5 | 39.6 | 40 | 23.4 | 11 |
| DP 5 + | | | | | |
| DP 6 | | | | | |

It is important to maximize the oligomeric DP 4, 5, 6 content while minimizing the DP 1 and 2 content for increased anti-redisposition performance (as shown in Example 39) and carbonate inhibition performance (as shown in Example 40) when used in the hybrid reactions. The enzyme degraded starches of Examples 25, 26 and 27 have a sum of DP 1 and DP 2<13.5% but the comparative DE 42 has a sum of DP 1 and DP 2>30%. Also, the enzyme degraded starches of Examples 25, 26 and 27 have a sum of DP 4, 5 and 6>39% while the comparative DE 10 has only 13%. All of the DP% above are measured as area% as measured by LC of the total DP of the oligosaccharide or polysaccharide

The enzyme degraded starches have a sum of DP 1 and DP 2<30, <25, <20 and preferably <16, and sum of DP 4, 5 and 6>15, >20, >25, and most preferably>35.

### Example 29

To a glass reactor was added 50 g of Example 25 and 60 g of water. The contents were heated to 87° C. with constant stirring. A monomer solution of 16.7 g acrylic acid and 40 g of water was added to the reactor contents over a period of 90 minutes. A concurrent feed of 2.2 g sodium persulfate dissolved in 60 g water was fed over the same interval. Upon completion of the feeds, the contents were cooked an additional 1 hour before being cooled to ambient. The result was a clear, homogeneous polymer solution.

### Example 30

To a glass reactor was added 50 g of Example 25 and 60 g of water. The contents were heated to 87° C. with constant stirring. A monomer solution of 8.8 g acrylic acid and 40 g of water was added to the reactor contents over a period of 90 minutes. A concurrent feed of 1.16 g sodium persulfate dissolved in 60 g water was fed over the same interval. Upon completion of the feeds, the contents were cooked an additional 1 hour before being cooled to ambient. The result was a clear, homogeneous polymer solution.

### Example 31

To a glass reactor was added 78.65 g of Example 25, 16.78 g of maleic anhydride, and 74.69 g of water. The contents were heated to 87° C. with constant stirring. 17.32 g of 50% NaOH was slowly added to the reactor when contents had reached 60° C. 0.00825 g of ferrous ammonium sulfate hexahydrate was added in 1 mL of water. A monomer solution of 25.3 g acrylic acid and 3 g of water was added to the reactor contents over a period of 4 hours. A concurrent feed of 1.84 g sodium persulfate dissolved in 7.33 g water and 14.85 g 35% hydrogen peroxide was fed over 4.25 hours. Upon completion of the feeds, the contents were cooked an additional 1 hour before being cooled to ambient. The result was a clear, dark, homogeneous polymer solution.

### Example 32

To a glass reactor was added 30 g of Example 25 and 60 g of water. The contents were heated to 98° C. with constant stirring. A monomer solution of 48 g 50% AMPS, 6 g methacrylic acid, and 18 g of water was added to the reactor contents over a period of 90 minutes. A concurrent feed of 0.83 g sodium persulfate dissolved in 60 g water was fed over the same interval. Upon completion of the feeds, the contents were cooked an additional 1 hour before being cooled to ambient. The result was a clear, homogeneous polymer solution.

### Example 33

To a glass reactor was added 30 g of Example 25and 60 g of water. The contents were heated to 98° C. with constant stirring. A monomer solution of 48 g 50% AMPS, 6 g acrylic acid, and 18 g of water was added to the reactor contents over a period of 90 minutes. A concurrent feed of 0.89 g sodium persulfate dissolved in 60 g water was fed over the same interval. Upon completion of the feeds, the contents were cooked an additional 1 hr before being cooled to ambient. The result was a clear, homogeneous polymer solution.

### Example 34

To a glass reactor was added 38 g of Example 25 and 160 g of water. The contents were heated to 98° C. with constant stirring. A monomer solution of 99.4 g 50% AMPS and 62.8 g acrylic acid was added to the reactor contents over a period of 90 minutes. A concurrent feed of 5 g sodium persulfate dissolved in 40 g water was fed over the same interval. Upon completion of the feeds, the contents were cooked an additional 1 hour before being cooled to ambient. The result was a clear, homogeneous polymer solution.

### Example 35

To a glass reactor was added 189 g of 94.4% DE 10 maltodextrin (Star Dri 10 from Tate and Lyle), 207.2 g pH 6.3 potassium phosphate buffer, 0.0898 g Validase HT 425 TL, and 0.0842 calcium sulfate The contents were heated to 92.5° C. with constant stirring and upon reaching temperature were cooked for 1 hr. To this mixture 9 g of 35% hydrogen peroxide was added. This mixture was cooked 10 more minutes. A monomer solution of 55.4 g acrylic acid and 5.8 g of 80% (2-dimethylamino)ethyl methacrylate) methyl chloride quaternary salt in water was added to the reactor contents over a period of 120 minutes. A concurrent feed of 7.6 g sodium persulfate dissolved in 86.4 g water was fed over 145 minutes. Upon completion of the feeds, the contents were cooked an additional 1 hour before being cooled to 50° C. The contents were partially neutralized with 30 g of 50% NaOH The result was a clear, homogeneous polymer solution.

### Example 36

To a glass reactor was added 94.6 g of 94.4% DE 10 maltodextrin (Star Dri 10 from Tate and Lyle), 103.6 g water, 0.02 g 25% NaOH, 0.0449 g Validase HT 425 TL, and 1.24 g 1% calcium ion solution from calcium sulfate and water The contents were heated to 92.5° C. with constant stirring and upon reaching temperature were cooked for 1 hr. Contents were cooled to 87° C. To this mixture 4.5 g of 35% hydrogen peroxide was added. This mixture was cooked 10 more minutes. 30 g acrylic acid was added to the reactor contents over a period of 120 minutes. A concurrent feed of 3.95 g sodium persulfate dissolved in 43.2 g water was fed over 145 minutes. Upon completion of the feeds, the contents were cooked an additional 1 hour before being cooled to 50° C. The contents were partially neutralized with 15 g of 50% NaOH. The result was a clear, homogeneous polymer solution.

### Example 37

To a glass reactor was added 94.6 g of 94.4% DE 10 maltodextrin (Star Dri 10 from Tate and Lyle), 103.6 g pH 6.3 potassium phosphate buffer solution, 0.0449 g Validase HT 425 TL, and .0421 g calcium sulfate in 5 mL water. The contents were heated to 92.5° C. with constant stirring and upon reaching temperature were cooked for 1 hr. Contents were cooled to 87° C. To this mixture 4.5 g of 35% hydrogen peroxide was added. This mixture was cooked 10 more minutes. To this mixture was added 11.9 g maleic anhydride and 0.0050 g ferrous ammonium sulfate hexahydrate. After dissolution, the contents were partially neutralized with 9.8 g 50% NaOH. 17.8 g acrylic acid in 15 g water was added to the reactor contents over a period of 3 hours. A concurrent feed of 1.9 g sodium persulfate dissolved in 10 g water and 14.2 g 35% hydrogen peroxide was fed over 3.25 hours. Upon completion of the feeds, the contents were cooked an additional 1 hour before being cooled to 50° C. The contents were partially neutralized with 12.4 g of 50% NaOH The result was a clear, homogeneous polymer solution.

### Example 38

To a glass reactor was added 38 g of 94.4% DE 10 maltodextrin (Star Dri 10 from Tate and Lyle), 41.6 g pH 6.3 potassium phosphate buffer solution, 0.0180 g Validase HT 425 TL in 1 mL water, and 0.0169 g calcium sulfate in 1 mL water. The contents were heated to 92.5° C. with constant stirring and upon reaching temperature were cooked for 1 hr. Contents were cooled to 87° C. To this mixture 1.8 g of 35% hydrogen peroxide was added. This mixture was cooked 10 more minutes. 12.1 g acrylic acid in 5.5 g water was added to the reactor contents over a period of 120 minutes. A concurrent feed of 1.6 g sodium persulfate dissolved in 17.4 g water was fed over 145 minutes. Upon completion of the feeds, the contents were cooked an additional 1 hour before being cooled to 50° C. The contents were partially neutralized with 6 g of 50% NaOH The result was a clear, homogeneous polymer solution.

### Example 39

### Laundry: Anti-Redeposition

### Anti-Redeposition Test Description:

Clay anti-redeposition performance was evaluated using a tergotometer (Model 7243E from TestFabrics, Inc.).

For each polymer (or no-polymer blank to be tested), an initial wash run was performed with each of the following components added:
1 Bradley Clay swatch (˜500 mg soil)
1 L of local city water with water hardness adjusting salt (to 250 ppm): 0.50 g CaCl₂·2H₂O and 0.66 g MgCl₂·6H₂O
1.00 g rudimentary detergent (Natural Powder Detergent, Free and Clear from 7th Generation)
20 ppm polymer additive (absent in negative control).
(2) 3″×4″ 100% cotton knit fabric swatch* (style 460-60)
(2) 3″×4″ 50/50 polyester/cotton swatch* (style 7422)
* Swatches were purchased at: Testfabrics, Inc.

Swatches had been pre-scanned with a spectrophotometer (L*a*b* and WI, Minolta Spectrophotometer CM-508-d). The wash process was carried out at 30° C., and agitation lasted for 15 minutes. Each terg pot was decanted and 1 L of un-adjusted city water was introduced. Rinsing at 23° C. with agitation lasted for 5 minutes. This rinse procedure was repeated, but for a 3-minute duration. The rinse water was decanted; the test swatches wrung out manually and dried at high heat in a conventional drier. Once dry, the swatches were again scanned. The whiteness index is measured on the swatches before and after the test. The ΔWI is the difference in the white index measured before and after the test. The lower the ΔWI and the whiter the swatches and the better the anti-redeposition performance.

### Results:

Antiredep WI CIE Values of Cotton Swatches from Tergotometer Tests

| ΔWI values | Test 1 | Test 2 | Test 3 | Test 4 |
|---|---|---|---|---|
| No polymer | 87.4 | 74.8 | 89.2 | 81.4 |
| Comparative Example 6 | 23.1 | | | 29.6 |
| Comparative Example 7 | | 32.4 | 32.7 | |
| Example 38 | | | 14.5 | 16.3 |
| Example 37 | | | 18.8 | 21.8 |

Antiredep WI CIE Values of Poly/Cotton Swatches from Tergotometer Tests

| ΔWI values | Test 1 | Test 2 | Test 3 | Test 4 |
|---|---|---|---|---|
| No polymer | 76.5 | 65.7 | 79.8 | 67.9 |
| Comparative Example 6 | 16.9 | | | 20.2 |
| Comparative Example 7 | | 23.4 | 23.1 | |
| Example 38 | | | 10.3 | 12.8 |
| Example 37 | | | 13.3 | 14.2 |

These data in the tables above indicate that the anti-redeposition performance of hybrids from enzyme degraded starches of Examples 37 and 38 are superior to that of the comparative Examples 6 and 7 which are hybrids from corn syrups or maltodextrins as the ΔWI numbers are much lower for both cotton and poly/cotton swatches.

### Example 40: Calcium Carbonate Inhibition

Examples' performance as threshold inhibitors for calcium carbonate was evaluation through a static, open-capped calcium carbonate inhibition test.

### Solution Preparation:

All chemicals used were reagent grade and weighed on an analytical balance to +/−0.0005 g of the indicated value. All solutions were made within thirty days of testing. The hardness and alkalinity solutions were prepared by filling to volume a one liter volumetric flask with deionized water after the following amount of salts added: 250 Cycle Hardness Solution:
36.6838g CaCl·2HO
25.0836 g MgCl·6HO
0.6127 g LiCl
250 Cycle Alkalinity Solution:
48.98.63 g NaHCO
7.0659 g NaCO

### Test Procedure:

An incubator shaker was turned on and set for a temperature of 50° C. to preheat. 97.6 g deionized H2O was dispensed into each Erlenmeyer flask: each example dosage was run in triplicate. One flask was prepared with no treatment added to it, to serve as a blank. Using a 2.5 mL electric pipette,1.20 mL of hardness solution was added to each flask, followed by dispensing of treatment polymer solution to produce the desired treatment dosage, and finally 1.20 mL of alkalinity solution was added to each flask. All flasks were placed uncapped into a shaker oven at 250 rpm and 50° C. for 17 hours. A “Total” solution was prepared with 97.6 g deionized water, 1.20 mL of hardness solution, and an addition 1.20 mL of deionized water and left outside the shaker, at ambient temperature over the same time period, capped.

Flasks were removed, capped, and allowed to cool. Each sample solution (including the blank and the total) was filtered through a 0.2 um filter membrane and dosed with enough 10% nitric acid solution to obtain an amount of 2.5% nitric acid in the filtered solution. Samples were analyzed for calcium and lithium content via an Inductively Couple Plasma (ICP) Optical Emission System. After correcting for dilution during acidification, % inhibition was determined by the following formula:

(ppm Ca in sample×ppm Li in Total/ppm Li in Sample−ppm Ca in Blank×ppm Li in Total/ppm Li in Blank)/

(ppm Ca in Total−ppm Ca in Blank×ppm Li in Total/ppm Li in Blank)×100%

ppm polymer

| Example | 5 | 6 | 7 | 8 |
|---|---|---|---|---|
| Comparative | 48 | 57 | 62 | 64 |
| Example 5 | | | | |
| Example 38 | 50 | 63 | 71 | 78 |

The higher the calcium carbonate inhibition number is the better the performance These data clearly show that the calcium carbonate inhibition numbers of the hybrid polymers produced from the enzyme degraded starches are superior to that of the comparative polymer produced from regular corn syrup DE 42.

### Example 41: Calcium Phosphate Inhibition at 20 ppm

Two brines were prepared.

Brine 1 was prepared as follows:
4.401 g CaCl₂·2H₂O
0.028 g Fe(NH₄)₂(SO₄)₂·6H₂O

Salts were added to a 3 L volumetric flask and filled to volume with deionized water

Brine 2 was prepared as follows:
0.09 g Na₂HPO₄
0.072 g Na₂B₄O₇·10H₂O

Salts were added to a 3 L volumetric flask and filled to volume with deionized water.

For each sample to be prepared, 50 g of Brine 1 was added to a 125 mL Erlenmeyer flask, followed by the desired amount of polymer treatment (added as a 1% solution), and to that was added 50 g of Brine 2. Each polymer sample was dosed at 20 ppm active and prepared in triplicate. A Blank sample containing no polymer and a Total sample containing only 50 g Brine 2 and 50 g of deionized water were also prepared. Samples were capped and placed in a 70 C oven overnight. Samples were then filtered through 2 um filter paper and analyzed via Hach method 480 for phosphate content.

Phosphate inhibition was determined by the formula (ppm P in Sample−ppm P in Blank)/(ppm P in Total−ppm P in Blank)×100%

| Example | % phosphate inhibition |
|---|---|
| Example 32 | 82 |
| Example 34 | 92 |

A phosphate inhibition performance of greater than 80% in this test is considered to be good. These data showed that the polymers of this present disclosure are good phosphate scale inhibitors.

### Example 42

An automatic zero phosphate dishwash formulations.

Formulation

| | A | B |
|---|---|---|
| | Weight | Weight |
| | percent | percent |
| tri-Sodium citrate - 2 H₂O | 10-30 | 10-30 |
| glutamic acid N,N-diacetic acid | 15-35 | 15-35 |
| (GLDA) or methylglycine N,N- | | |
| diacetic acid (MGDA) | | |
| Sodium carbonate | 15-25 | 15-25 |
| Sodium percarbonate | 10 | 10 |
| Sodium disilicate | 5 | 5 |
| TAED | 5 | 5 |
| Protease (e.g. Ovozyme 64T) | 3 | 3 |
| Amylase (e.g. Stainzyme 12T) | 2 | 2 |
| Polymer of Example 3 | 1-10 | |
| Polymer of Example 12 | | 1-10 |
| Synperonic 810 | 2.5 | 2.5 |
| Synperonic 850 | 2.5 | 2.5 |
| Sodium sulfate | Rest | Rest |

### Example 43

### Automatic Zero Phosphate Dishwash Powder Formulation

| Ingredients | wt % |
|---|---|
| Sodium citrate | 30 |
| Sodium carbonate | 20 |
| Polymer of Example 10 | 1 to10 |
| Sodium disilicate | 10 |
| Perborate monohydrate | 6 |
| Tetraacetylethylenediamine | 2 |
| Enzymes | 2 |
| Sodium sulfate | 10 |

### Example 44—Personal Care Formulation Using Rheology Modifier

200 grams of a personal care body wash gel was prepared by adding 23.5 grams of Example 22 (2.5% active polymer) to 54.4 grams of deionized water in a 250 ml beaker. A 1 ½ inch jiffy mixer blade was inserted into the beaker and attached to an overhead mixer. The batch was allowed to mix with a vortex extending to the middle of the beaker. This was followed by adding 100 grams of sodium laureth sulfate (25.2% active Standapol ES-2 from BASF). This was allowed to mix for 15 minutes. 1.97 grams of 25% sodium hydroxide was added dropwise and solution was mixed for 15 minutes. Then, 14.8 grams of cocamidopropyl betaine (Crodateric CAB 30, Croda Inc.) was added and mixed for another 15 minutes. 0.1 grams of (ethylenedinitrilo)tetraacetic acid, tetrasodium salt, was added and the batch was mixed until homogenous. 0.5 grams of sodium benzoate was added to the batch and mixed until homogenous. The pH was then adjusted to 5.0+/−0.2 using 7.2 grams of 20% citric acid. The batch was mixed for 15 minutes and then left for 24 hours upon which it was centrifuged. The viscosity was measured using Brookfield DV-I+Viscometer at 10 rpm using with spindle 6 and clarity was measured using HACH 2100AN Turbidimeter. This body wash gel had a viscosity of 9500 cps and clarity of 40 NTU.

### Example 45—Personal Care Formulation Using Rheology Modifier

200 grams of typical shampoo formulation was prepared by adding 26.6 grams of Example 23 (2.5% active polymer) to 50.3 grams of deionized water in a 250 ml beaker. A 1 ½ inch jiffy mixer blade was inserted into the beaker and attached to an overhead mixer. The batch was allowed to mix with a vortex extending to the middle of the beaker. This was followed by adding 100 grams of sodium laureth sulfate (25.2% active Standapol ES-2 from BASF). This was allowed to mix for 15 minutes. 1.97 grams of 25% sodium hydroxide was added dropwise and solution was mixed for 15 minutes. Then, 14.8 grams of cocamidopropyl betaine (Crodateric CAB 30, Croda Inc.) was added and mixed for another 15 minutes. 0.1 grams of (ethylenedinitrilo)tetraacetic acid, tetrasodium salt, was added and the batch was mixed until homogenous. 0.5 grams of sodium benzoate was added to the batch and mixed until homogenous. The pH was then adjusted to 5.0+/−0.2 using 7.2 grams of 20% citric acid as needed. The batch was mixed for 15 minutes and then left for 24 hours upon which it was centrifuged. The viscosity was measured using Brookfield DV-I+Viscometer at 10 rpm using with spindle 6 and clarity was measured using HACH 2100AN Turbidimeter. The final formulation had a viscosity of 3500 cps and clarity of 350 NTU.

### Example 46

To a glass reactor was added 92.27 grams water and 97 grams of the enzyme degraded starch of for Example 25 (91.2%). The mixture was heated to 85 C with constant stirring. 29.57 grams acrylic acid was added over a period of 2 hours. A solution of 15.52 grams water and 29.56 grams 50% NaOH was added simultaneously to the reactor over the same time period. A third solution of 3.9 grams sodium persulfate dissolved in 42.9 grams water was added simultaneous to the other two additions, but over 2.5 hours. After the completion of the sodium persulfate slow addition, the reactor contents were cooked at 85 C for 1 hr. Then the contents were cooled to room temperature and the product was a brown, homogeneous solution polymer. The absorbance number when tested as in Example 5 was 0.438 at 520 nm.

50 grams of this polymer was adjusted to pH 9 with 1.4 grams of 25% NaOH solution, with constant stirring. In a glass reactor, the solution polymer was heated to 45 C with vigorous stirring. A solution of 3.27 grams 12% sodium borohydride diluted to 10 mL with water was added to the reactor contents, subsurface, over the course of 0.5 hours. The contents were stirred at temperature for an additional 2.5 hours after the sodium borohydride addition was completed. The absorbance number when tested as in Example 5 was 0.210 at 520 nm.

This color was determined to be too dark and therefore an additional 1.6 grams 12% sodium borohydride diluted to 10 mL with water was added to the reactor contents, subsurface, over the course of 0.5 hours. The contents were stirred at temperature for an additional 2.5 hours after the sodium borohydride addition was completed. The material was cooled to room temperature and adjusted to pH 7.23 with 13 grams of 25% sulfuric acid in water. The final product had a solids content of 34.1%. The absorbance number when tested as in Example 5 was 0.016 at 520 nm. This color was deemed acceptable. This example illustrates how the borohydride addition can be manipulated to give a desired level of low color in a simulated alkaline aging test.

### Example 47

### Step I: Synthesis of the Hybrid Polymer

An initial charge containing a solution of 262.2 grams of Staley 1300 (DE 42 corn syrup, 83% aqueous solution from Tate and Lyle) and 225 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 72.0 grams of acrylic acid was added over 2 hours. A solution of 29 grams of 50% solution of sodium hydroxide in 38 grams of water was concurrently added over 2 hours. One minute into the feed, a solution of 9.5 grams of sodium persulfate dissolved in 104.15 grams of water was concurrently added over 1 hours and 55 minutes. At the end of feeds, the reactor temperature was maintained at 185-189° F. for an additional one hour. The reactor was then cooled down to room temperature. The final polymer solution had 38.5 mol % reducing end groups as measured by NMR as described in Example 20.

### Step II: Hydrogenation of the Hybrid Polymer

To a 600-mL autoclave, 85.1 grams of the polymer solution above, 4.2 grams of Raney Nickel A-7000 (lot: 70001732, Johnson & Matthey) catalyst, and 0.3 g of Calcinet filter aid was added. The reactor was heated to 120° C., padded to 5 psig with N₂, and pressurized with H₂ to 700 psig. The reactor was sampled and filtered using a syringe fitted with a 1 μm filter for NMR analysis. After 7 hours the reaction product had 3.1 mol % reducing end groups as measured by NMR and the reaction was stopped.

### Example 48

### Step I: Synthesis of the Hybrid Polymer

An initial charge containing a solution of 262.2 grams of Star Dri 240 (DE 24 corn syrup, from Tate and Lyle) and 225 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 9 grams of 35% hydrogen peroxide solution was charged to the reactor. Immediately after the 35% hydrogen peroxide solution was added, 72.0 grams of acrylic acid was added over 2 hours. A solution of 29 grams of 50% solution of sodium hydroxide in 38 grams of water was concurrently added over 2 hours. One minute into the feed, a solution of 9.5 grams of sodium persulfate dissolved in 104.15 grams of water was concurrently added over 1 hours and 55 minutes. At the end of feeds, the reactor temperature was maintained at 185-189° F. for an additional one hour. The reactor was then cooled down to room temperature. The final polymer solution had 23.2 mol % reducing end groups as measured by NMR.

### Step II: Hydrogenation of the Hybrid Polymer

To a 600-mL autoclave, 118.4 grams of the polymer solution above, 5.9 grams of Raney Nickel A-7000 (lot: 70001732, Johnson & Matthey) catalyst, and 0.5 g of Calcinet filter aid was added. The reactor was heated to 120° C., padded to 5 psig with N₂, and pressurized with H₂ to 700 psig. The reactor was sampled and filtered using a syringe fitted with a 1 μm filter for NMR analysis. After 9 hours the reaction product had 3.1 mol % reducing end groups as measured by NMR and the reaction was stopped.

### Example 49

An initial charge containing a solution of 277.2 grams of Hystar 3375 and 224 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.6 grams of maleic anhydride was charged to the reactor. At 187° F., 10 grams of 35% hydrogen peroxide solution was charged to the reactor Immediately after the 35% hydrogen peroxide solution was added, 114.5 grams of acrylic acid was added over 2 hours. A solution of 31.8 grams of 50% solution of sodium hydroxide in 64.4 grams of water was concurrently added over 2 hours. One minute into the feed, a solution of 7.56 grams of sodium persulfate and 116.6 grams of water was added over 1 hour 15 minutes. At the end of feeds, the reactor temperature was maintained at 185-189° F. for an additional one hour. The reactor was then cooled down to room temperature. The final polymer solution was light yellow in color and had a solids content of 40.7%.

### Example 50

An initial charge containing a solution of 217.5 grams of Hystar 3375, and 224 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 160.3 grams of acrylic acid was added over 2 hours. A solution of 44.5 grams of 50% solution of sodium hydroxide in 64.4 grams of water was concurrently added over 2 hours. One minute into the feed, a solution of 10.6 grams of sodium persulfate and 116.7grams of water was added over 1 hour 15 minutes. At the end of feeds, the reactor temperature was maintained at 185-189° F. for an additional one hour. The reactor was then cooled down to room temperature. The final polymer solution was light yellow in color and had a solids content of 41%.

### Example 51

An initial charge containing a solution of 177 grams of Hystar 3375, and 184 grams of water was added to a 2 liter 5 necked round bottom flask fitted with a condenser, heating mantle, temperature probe and controller and overhead stirring. The contents of the reactor were started to be heated to 187° F. When the temperature of the initial charge reached 140° F., 0.5 grams of maleic anhydride was charged to the reactor. At 187° F., 8.9 grams of 35% hydrogen peroxide solution was charged to the reactor Immediately after the 35% hydrogen peroxide solution was added, 160.3 grams of acrylic acid and 80 grams of 50% solution of sodium 2-acrylamido-2-methyl propane sulfonate was added over 2 hours. A solution of 44.5 grams of 50% solution of sodium hydroxide in 64.4 grams of water was concurrently added over 2 hours. One minute into the feed, a solution of 10.6 grams of sodium persulfate and 116.7grams of water was added over 1 hour 15 minutes. At the end of feeds, the reactor temperature was maintained at 185-189° F. for an additional one hour. The reactor was then cooled down to room temperature. The final polymer solution was light yellow in color and had a solids content of 41.6 and pH pf 4.5%.

### Example 52

The polymers of this present disclosure were tested in an automatic dishwash (ADW) application. The testing conditions were as follows:
Machines: Miele GSL2
Program: R65/10/K165 Running time ˜1 h 35 min, washing, 2 rinses and drying Water hardness: 21 German hardness with a Ca to Mg ratio of 3:1 made from CaCl₂, MgSO₄ and NaHCO₃
Formulation powder used per cycle: 18 g
Cycles: 10, 20 and 30 Evaluation by a panel on filming and spotting on a scale of 1-9 with 9 being the best and 1 being the worst.
Ballast soil: 25 g. The composition of the ballast soil was:

| Ingredient | Amount (g) |
|---|---|
| Demineralized water | 11.54 |
| Milk | 2.61 |
| Egg yolk powder | 1.50 |
| Gravy powder | 1.25 |
| Potato starch | 0.26 |
| Margarine | 5.22 |
| Mustard | 1.31 |
| Tomato ketchup | 1.31 |

The formulation tested was as follows:

| Ingredient | Amount | Function |
|---|---|---|
| Builder | 25% | Builder, Ca-ion binder |
| Polymer | 5% | CaCO3 scale control and dispersant |
| Na₄HEDP | 1.5 or | Sequestrant, transition metals binder |
| | 0.5% | |
| C16-C18 fatty alcohol | 5% | Surfactant, cleaning, rinsing |
| with 25 moles of | | |
| ethoxylation | | |
| Na-percarbonate | 15% | Oxidizing agent, bleach |
| Na-carbonate | 25% | Buffering agent, pH control |
| TAED | 2% | Bleach activator |
| Protease | 2.5% | Enzyme, cleaning |
| Amylase | 1.5% | Enzyme, cleaning |
| Zn-sulfate | 0.2% | Glass corrosion inhibitor |
| Na-disilicate | 5.0% | Buffering agent, pH control |
| Na-sulfate | 12.8 or | Bulking agent |
| | 13.8% | |

The results of the testing of after 20 cycles were as follows:

| | | | | | |
|---|---|---|---|---|---|
| Builder | | MGDA | Na-citrate | MGDA | Na-citrate |
| Builder | MGDA | MGDA | Na-citrate | MGDA | Na-citrate |
| Polymer | No polymer | Example 4 | Example 4 | Example 4 | Example 4 |
| Amount | 1.5% | 1.5% | 1.5% | 0.5% | 0.5% |
| Na₄HEDP | | | | | |
| Rating | 2.8 | 4.8 | 4.5 | 4.4 | 4.3 |
| Filming | | | | | |
| Rating | 6.3 | 7.0 | 7.0 | 7.0 | 7.0 |
| Spotting | | | | | |

These data showed that the polymers of this present disclosure work very well to minimize filming in spotting in automatic dishwash applications.

### Example 53

Phosphonates are coming under increasing regulatory pressure. Phosphonate free formulations of this present disclosure is below:

| Ingredient | Amount | Function |
|---|---|---|
| MGDA or GLDA | 0-50% | Builder, Ca-ion binder |
| Na-Citrate | 0-50% | Builder, Ca-ion binder |
| Polymers of Example | 2-8% | CaCO3 scale control and |
| 4 or 10 or 48 or 51 | | dispersant |
| C16-C18 fatty alcohol | 1-5% | Surfactant, cleaning, rinsing |
| with 25 moles of | | |
| ethoxylation | | |
| Na-percarbonate | 5-25% | Oxidizing agent, bleach |
| Na-carbonate | 5-50% | Buffering agent, pH control |
| TAED | 1-5% | Bleach activator |
| Protease | 1-5% | Enzyme, cleaning |
| Amylase | 1-5% | Enzyme, cleaning |
| Zn-sulfate | 0.1-0.5% | Glass corrosion inhibitor |
| Na-disilicate | 1-10% | Buffering agent, pH control |
| Na-sulfate | Up to 100% | Bulking agent |

### Example 54

### Liquid Laundry Formulation

| Ingredient | Weight percent active ingredient |
|---|---|
| C9-C13 alkylbenzene sulfonate | 0-20 |
| Sodium lauryl ether sulfate | 0-20 |
| C12-C14 fatty acid | 0-20 |
| C12-C15 alcohol ethoxylate | 0-20 |
| Polymers of Example 4 or 10 or 48 or | 0.5-5 |
| 51 | |
| GLDA/MGDA | 1-10 |
| Sodium chloride or sodium sulfate | 1-10 |
| Protease | 0.1-1 |
| Amylase | 0.1-1 |
| Mannase | 0.1-1 |
| sodium hydroxide | 0.1-5 |
| Water | Up to 100% |

While the present disclosure has been described in conjunction with the specific embodiments set forth above, many alternatives, modifications and other variations thereof will be apparent to those of ordinary skill in the art. All such alternatives, modifications and variations are intended to fall within the spirit and scope of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

What is claimed is:

1. A manufactured polymer comprising (A) a synthetic component covalently bonded to (B) a natural component, wherein the natural component comprises an oligosaccharide or a polysaccharide, and wherein an end group of said oligosaccharide or said polysaccharide is substantially devoid of aldehyde functionality when in an open-chain form.

2. The manufactured polymer according to claim 1, which is derived from a polymer precursor that terminates in aldehyde functionality when in open-chain form, said manufactured polymer comprising less than 5% of the aldehyde functionality of the polymer precursor.

3. The manufactured polymer according to claim 1, which is completely free of end group aldehyde functionality.

4. The manufactured polymer according to claim 2, which comprises alcoholic functionality replacing the aldehyde functionality of the polymer precursor.

5. The manufactured polymer according to claim 2, which comprises carboxylic functionality replacing the aldehyde functionality of the polymer precursor.

6. The manufactured polymer according to claim 1, chosen from a hybrid copolymer, a sulfonated graft copolymer, a low molecular weight graft copolymer, a hybrid dendrite copolymer, a graft dendrite copolymer.

7. The manufactured polymer according to any claim 1, which comprises the following structure: 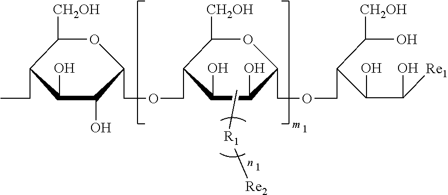
wherein
Re₁ represents an alcohol or a carboxylic acid group;
m₁ is from 0-98;
n₁ is from 20-100;
R₁ is an individual monomer residue chosen from a (meth)acrylic acid monomer, itaconic acid monomer, maleic acid monomer and mixtures thereof; and
Re₂ represents a H or a sulfate group.

8. The manufactured polymer according to claim 1, which comprises the following structure: 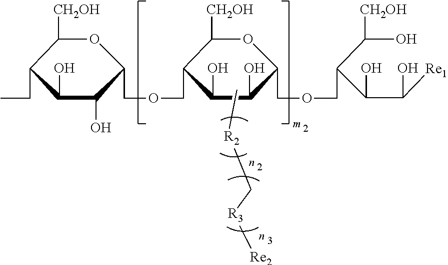
wherein
Re₁ represents an alcohol or a carboxylic acid group;
m₂ is from 0-9998;
n₂ is greater than 1000;
R₂ is an individual monomer residue derived from an anionic ethylenically unsaturated monomer;
n₃ is greater than 1000;
R₃ is an individual monomer residue derived from a hydrophobic ethylenically unsaturated monomer; and
Re₂ represents H or a sulfate group.

9. The manufactured polymer according to claim 1, which is substantially free of added phosphorus.

10. A manufactured polymer comprising (A) a synthetic component covalently bonded to (B) a natural component, wherein the natural component comprises a mixture comprising a monosaccharide having an oligomeric degree of polymerization DP1, a disaccharide having an oligomeric degree of polymerization DP2, a tetrasaccharide having an oligomeric degree of polymerization DP4, a pentasaccharide having an oligomeric degree of polymerization DP5, and a hexasaccharide having an oligomeric degree of polymerization DP6, wherein a sum of DP1+DP2 is less than 30 and a sum of DP4+DP5+DP6 is greater than 15.

11. The manufactured polymer according to claim 10, chosen from a hybrid copolymer, a sulfonated graft copolymer, a low molecular weight graft copolymer, a hybrid dendrite copolymer, a graft dendrite copolymer.

12. The manufactured polymer according to claim 10, which comprises the following structure: 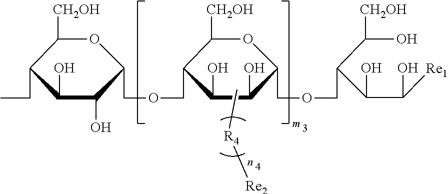
wherein
Re₁ represents an aldehyde, alcohol or a carboxylic acid group;
m₃ is from 1 to 98;
n₄ is from 20-100;
R₄ is an individual monomer residue chosen from a (meth)acrylic acid monomer, itaconic acid monomer, maleic acid monomer and mixtures thereof; and
Re₂ represents H or a sulfate group.

13. A process of preparing a manufactured polymer according to claim 1, said process comprising the following steps: (A) providing a polymer precursor mixture comprising (i) one or more monomer precursors of the synthetic component and (ii) an oligosaccharide or a polysaccharide comprising end groups having the ability to exist in an open-chain form comprising aldehyde functionality; and (B) polymerizing the polymer precursor mixture to form a manufactured polymer, wherein either before or after step (B), the aldehyde functionality is eliminated in whole or substantial part.

14. The process according to claim 13, which further comprises adding hydrogen peroxide to the polymer precursor mixture before step (B) to reduce aldehyde functionality.

15. The process according to claim 14, which comprises removing residual hydrogen peroxide before step (B).

16. The process according to claim 13, which further comprises adding sodium borohydride to the manufactured polymer after step (B) to reduce aldehyde functionality.

17-20. (canceled)

21. A formulation comprising a manufactured polymer according to claim 1 and comprising at least one of a builder, a surfactant, and an enzyme.

22-31. (canceled)
